(19) United States
(12) Patent Application Publication
(10) Pub. No.: US 2023/0156483 A1
(43) Pub. Date: May 18, 2023

(54) STATION PLACEMENT SUPPORT METHOD, STATION PLACEMENT SUPPORT APPARATUS AND STATION PLACEMENT SUPPORT PROGRAM

(71) Applicant: NIPPON TELEGRAPH AND TELEPHONE CORPORATION, Tokyo (JP)

(72) Inventors: Hideyuki TSUBOI, Musashino-shi, Tokyo (JP); Hideki TOSHINAGA, Musashino-shi, Tokyo (JP); Kazuto GOTO, Musashino-shi, Tokyo (JP); Tatsuhiko IWAKUNI, Musashino-shi, Tokyo (JP); Shuki WAI, Musashino-shi, Tokyo (JP); Daisei UCHIDA, Musashino-shi, Tokyo (JP); Yushi SHIRATO, Musashino-shi, Tokyo (JP); Naoki KITA, Musashino-shi, Tokyo (JP); Takeshi ONIZAWA, Musashino-shi, Tokyo (JP)

(73) Assignee: NIPPON TELEGRAPH AND TELEPHONE CORPORATION, Tokyo (JP)

(21) Appl. No.: 17/915,070

(22) PCT Filed: Mar. 30, 2020
(86) PCT No.: PCT/JP2020/014535

§ 371 Date: Sep. 27, 2022

(51) Int. Cl. H04W 16/18

(52) U.S. Cl. CPC H04W 16/18

(57) ABSTRACT

A station deployment support method includes a positional relationship identification step of, based on travel trajectory data of a mobile object that measures an object present in a three-dimensional space within a predetermined measurable distance and acquires point group data on the measured object, the measurable distance, candidate base station position data, and candidate terminal station position data, generating base station positional relationship identification data and terminal station positional relationship identification data; a measurable range identification step of generating measurable range data based on the travel trajectory data and the measurable distance; and a travel trajectory selection step of selecting at least one piece of travel trajectory data so that the proportion of the measurable range in a predetermined evaluation area satisfies a predetermined value.

### TECHNICAL FIELD

The present invention relates to a station deployment support method, a station deployment support apparatus, and a station deployment support program.

### BACKGROUND ART

FIG. 32 is a partially modified schematic view of, regarding TIP (Telecom Infra Project) that is a consortium working together to accelerate the openness of the specifications of the general communication network devices (main members: Facebook, Deutsche Telecom, Intel, NOKIA, etc.), a use case proposed by mmWave Networks as a reference (for example, see Non-Patent Literatures 1 to 3). The mmWave Networks is one of the project groups of TIP and is aiming at constructing a network that is inexpensive and faster than deploying an optical fiber, using millimeter-wave radio signals in an unlicensed band.

Referring to buildings, such as buildings 800 and 801 and houses 810, 811, and 812, illustrated in FIG. 32, each of terminal station apparatuses (hereinafter referred to as “terminal stations”) 840 to 844, which are installed on wall surfaces of the respective buildings, and base station apparatuses (hereinafter referred to as “base stations”) 830 to 834, which are installed on utility poles 821 to 826, is an apparatus called mmWave DN (Distribution Node).

Each of the base stations 830 to 834 is connected to one of communication apparatuses provided in telephone exchange stations (Fiber PoP (Point of Presence)) 850 and 851 by an optical fiber 900 or 901. The communication apparatuses are connected to a communication network of a provider. The mmWave Link, that is, millimeter-wave wireless communication is performed between one of the terminal stations 840 to 844 and one of the base stations 830 to 834 (hereinafter also referred to as “between the two stations”). In FIG. 32, millimeter-wave wireless links are indicated by alternate long and short dash lines.

In a configuration in which the base stations 830 to 834 are installed on the utility poles 821 to 826, the terminal stations 840 to 844 are installed on the wall surfaces of the buildings, and millimeter-wave wireless communication is performed between the two stations, the act of selecting candidate positions for installing the base stations 830 to 834 and the terminal stations 840 to 844 is referred to as station deployment design (hereinafter also referred to as “station deployment”).

### CITATION LIST

### Non-Patent Literature

Non-Patent Literature 1: Sean Kinney, “Telecom Infra Project focuses on millimeter wave for dense networks, Millimeter Wave Networks Project Group eyes 60 GHz band”, Image courtesy of the Telecom Infra Project, RCR Wireless News, Intelligence on all things wireless, Sep. 13, 2017, [searched Mar. 6, 2020], the website (URL: https://www.rcrwireless.com/20170913/carriers/telecom-infra-project-millimeter-wave-tag17)
Non-Patent Literature 2: Frederic Lardinois, “Facebook-backed Telecom Infra Project adds a new focus on millimeter wave tech for 5G”, [searched Mar. 6, 2020], the website (URL: https://techcrunch.com/2017/09/12/facebook-backed-telecom-infra-project-adds-a-new-focus-on-millimeter-wave-tech-for-5g/?renderMode=ie11)
Non-Patent Literature 3: Jamie Davies, “DT and Facebook TIP the scales for mmWave”, GLOTEL AWARDS 2019, telecoms.com, Sep. 12, 2017, [searched Mar. 6, 2020], the website (URL: http://telecoms.com/484622/dt-and-facebook-tip-the-scales-for-mmwave/)

### SUMMARY OF THE INVENTION

### Technical Problem

As a method of station deployment design, there is known a method that uses three-dimensional point group data obtained by capturing an image of a space. Such a method includes, for example, first driving a mobile object, such as a vehicle, having an MMS (Mobile Mapping System) mounted thereon along a road around a residential area as an evaluation target to acquire three-dimensional point group data, and then evaluating wireless communication between one of the base stations 830 to 834 and one of the terminal stations 840 to 844 utilizing the acquired point group data. As an evaluation means, there is known a means of determining three-dimensional visibility or a means of calculating the shield factor for a space between the two stations. The “shield factor” herein is an index indicating the degree of influence of an object, which is present between one of the base stations 830 to 834 and one of the terminal stations 840 to 844, on the wireless communication, and may also be referred to as “transmissivity” from the opposite perspective. To implement such an evaluation means, it is necessary to prepare point group data on all evaluation targets in the space including the candidate positions of the base stations 830 to 834 and the terminal stations 840 to 844.

However, even when a mobile object having an MMS mounted thereon has traveled extensively in advance in an area set as an evaluation target by an apparatus for supporting station deployment design, there are many places from which point group data has been partially difficult to obtain. Alternatively, when the range of the evaluation target contains no point group data at all, it is necessary to collect new point group data. However, when the mobile object has already traveled in the range of the evaluation target, it is often the case that only the point group data that has been already obtained through the travel is used. If station deployment design is performed with the apparatus based on such point group data with partially missing information, a processing result with low accuracy may be output.

For example, assume that even when there is an object in a space between the base station 830 and the terminal station 840, point group data on the object has not been acquired. In such a case, even if an apparatus for supporting station deployment performs three-dimensional visibility determination or shield factor calculation for the space between the two stations utilizing the acquired point group data, the apparatus performs a process on the assumption that there is no shielding object between the two stations because there is no point group data on the space between the two stations. Consequently, the apparatus for supporting station deployment design may erroneously determine that the space is “visible” or erroneously calculate the shield factor as a “low shield factor” that is sufficient to perform wireless communication. Therefore, the reliability of the processing result may decrease, which in turn may prompt a user to perform erroneous determination, for example, install the terminal station 840 on a wall surface of an inappropriate building.

There is also a case where one of the base station 830 and the terminal station 840 is present in the range in which point group data has not been acquired or is not present in the range around the travel trajectory of a mobile object having an MMS mounted thereon. In such a case also, a three-dimensional visibility determination or shield factor calculation process may be influenced depending on the positional relationship among the base station 830, the terminal station 840, and the travel trajectory. Therefore, the reliability of the processing result may decrease, which in turn may prompt a user to perform erroneous determination.

In view of the foregoing circumstances, it is an object of the present invention to provide a technique that allows a user to perform appropriate station deployment design by improving the state of acquisition of point group data from a space between a candidate position for installing a base station and a candidate position for installing a terminal station.

### Means for Solving the Problem

An aspect of the present invention is a station deployment support method including a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position; a measurable range identification step of generating measurable range data indicating a measurable range based on the travel trajectory data and the measurable distance; and a travel trajectory selection step of selecting at least one piece of travel trajectory data so that a proportion of the measurable range in a predetermined evaluation area satisfies a predetermined value.

In addition, an aspect of the present invention is a station deployment support apparatus including a positional relationship identification unit that, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generates base station positional relationship identification data indicating a positional relationship between the travel trajectory and a candidate base station position, and terminal station positional relationship identification data indicating a positional relationship between the travel trajectory and a candidate terminal station position; a measurable range identification unit that generates measurable range data indicating a measurable range based on the travel trajectory data and the measurable distance; and a travel trajectory selection unit that selects at least one piece of travel trajectory data so that a proportion of the measurable range in a predetermined evaluation area satisfies a predetermined value.

In addition, an aspect of the present invention is a station deployment support program for causing a computer to execute a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position; a measurable range identification step of generating measurable range data indicating a measurable range based on the travel trajectory data and the measurable distance; and a travel trajectory selection step of selecting at least one piece of travel trajectory data so that a proportion of the measurable range in a predetermined evaluation area satisfies a predetermined value.

### Effects of the Invention

The present invention allows a user to perform appropriate station deployment design by improving the state of acquisition of point group data from a space between a candidate position for installing a base station and a candidate position for installing a terminal station.

### BRIEF DESCRIPTION OF DRAWINGS

FIG. 1 is a block diagram illustrating the configuration of a station deployment support apparatus of a first embodiment.

FIG. 2 is a flowchart illustrating a process flow of the station deployment support apparatus of the first embodiment.

FIG. 3 is a view for describing a process of the station deployment support apparatus of the first embodiment in two stages.

FIG. 4 is a block diagram illustrating the configuration of a point group data processing unit in a station deployment support apparatus of a second embodiment.

FIG. 5 is a view illustrating the configuration of the positional relationship among a travel trajectory, a candidate base station position, and a candidate terminal station position in the second embodiment.

FIG. 6 is a view illustrating the configuration of the positional relationship among a travel trajectory, a candidate base station position, and a candidate terminal station position in the second embodiment.

FIG. 7 is a view illustrating the configuration of the positional relationship among a travel trajectory, a candidate base station position, and a candidate terminal station position in the second embodiment.

FIG. 8 is a view illustrating the configuration of the positional relationship among a travel trajectory, a candidate base station position, and a candidate terminal station position in the second embodiment.

FIG. 9 is a view illustrating the configuration of the positional relationship among a travel trajectory, a candidate base station position, and a candidate terminal station position in the second embodiment.

FIG. 10 is a view illustrating the configuration of the positional relationship among a travel trajectory, a candidate base station position, and a candidate terminal station position in the second embodiment.

FIG. 11 is a view illustrating the configuration of the positional relationship among a travel trajectory, a candidate base station position, and a candidate terminal station position in the second embodiment.

FIG. 12 is a view illustrating the configuration of the positional relationship among a travel trajectory, a candidate base station position, and a candidate terminal station position in the second embodiment.

FIG. 13 is a view illustrating the configuration of the positional relationship among a travel trajectory, a candidate base station position, and a candidate terminal station position in the second embodiment.

FIG. 14 is a view illustrating the configuration of the positional relationship among a travel trajectory, a candidate base station position, and a candidate terminal station position in the second embodiment.

FIG. 15 is a flowchart illustrating a process flow of a point group data processing unit in the station deployment support apparatus of the second embodiment.

FIG. 16 is a view illustrating the positional relationship between an evaluation area and a travel trajectory in a third embodiment.

FIG. 17 is a view illustrating the positional relationship between the evaluation area and the travel trajectory in the third embodiment.

FIG. 18 is a view illustrating the positional relationship between the evaluation area and the travel trajectory in the third embodiment.

FIG. 19 is a view illustrating the positional relationship between the evaluation area and the travel trajectory in the third embodiment.

FIG. 20 is a chart illustrating the effect of superposition of travel trajectories with a station deployment support apparatus of the third embodiment.

FIG. 21 is a block diagram illustrating the configuration of a point group data processing unit in the station deployment support apparatus of the third embodiment.

FIG. 22 is a flowchart illustrating a process flow of the point group data processing unit in the station deployment support apparatus of the third embodiment.

FIG. 23 is a view illustrating the positional relationship between an evaluation area and a travel trajectory in a fourth embodiment.

FIG. 24 is an enlarged view illustrating the positional relationship between the evaluation area and the travel trajectory in the fourth embodiment.

FIG. 25 is a view illustrating the configuration of the positional relationship among a travel trajectory, a candidate base station position, a candidate terminal station position, and a truck in a fifth embodiment.

FIG. 26 is a graph illustrating an exemplary transition of the shield factor of a space between the candidate base station position and the candidate terminal station position in the fifth embodiment.

FIG. 27 is a flowchart illustrating a process flow of a station deployment support apparatus of the fifth embodiment.

FIG. 28 is a view illustrating the configuration of the positional relationship among a travel trajectory, a candidate base station position, a candidate terminal station position, and a tree in a sixth embodiment.

FIG. 29 is a view illustrating the configuration of the positional relationship among a travel trajectory, a candidate base station position, a candidate terminal station position, and a tree in the sixth embodiment.

FIG. 30 is a graph illustrating an exemplary transition of the shield factor of a space between the candidate base station position and the candidate terminal station position in the sixth embodiment.

FIG. 31 is a flowchart illustrating a process flow of a station deployment support apparatus of the sixth embodiment.

FIG. 32 is a view illustrating an example of a use case proposed by TIP.

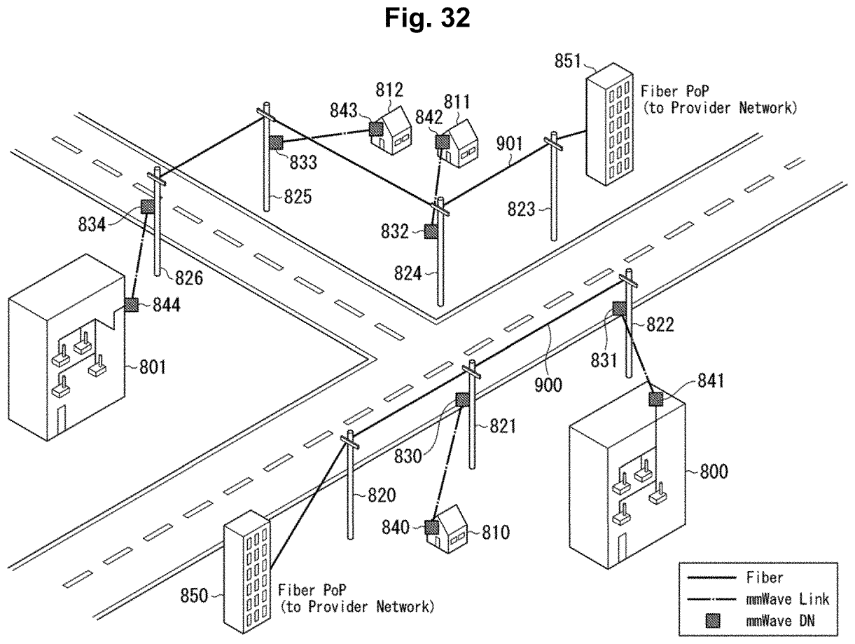

### DESCRIPTION OF EMBODIMENTS

### First Embodiment

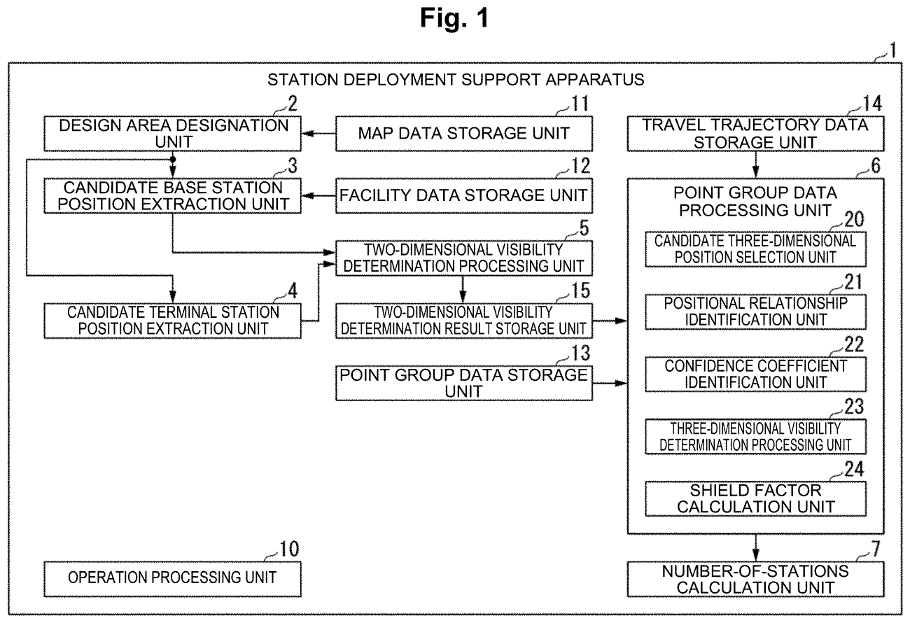

Hereinafter, a first embodiment of the present invention will be described with reference to the drawings. FIG. 1 is a block diagram illustrating the configuration of a station deployment support apparatus 1 that is an apparatus for supporting station deployment design of the first embodiment. The station deployment support apparatus 1 includes a design area designation unit 2, a candidate base station position extraction unit 3, a candidate terminal station position extraction unit 4, a two-dimensional visibility determination processing unit 5, a point group data processing unit 6, a number-of-stations calculation unit 7, an operation processing unit 10, a map data storage unit 11, a facility data storage unit 12, a point group data storage unit 13, a travel trajectory data storage unit 14, and a two-dimensional visibility determination result storage unit 15. The point group data processing unit 6 includes a candidate three-dimensional position selection unit 20, a positional relationship identification unit 21, a confidence coefficient identification unit 22, a three-dimensional visibility determination processing unit 23, and a shield factor calculation unit 24.

Described below is data stored in advance in the map data storage unit 11, the facility data storage unit 12, the point group data storage unit 13, and the travel trajectory data storage unit 14 of the station deployment support apparatus 1.

The map data storage unit 11 stores two-dimensional map data in advance. The map data includes, for example, data indicating the position and the shape of a candidate building in which a terminal station is to be installed, data indicating the range of the site of the building, and data indicating a road. The facility data storage unit 12 stores candidate base station position data on the two-dimensional coordinate system (hereinafter referred to as “candidate two-dimensional base station position data”) indicating a candidate base station installation building structure that is an outdoor facility, such as a utility pole, on which a base station is to be installed.

The point group data storage unit 13 stores three-dimensional point group data acquired by an MMS, for example. The travel trajectory data storage unit 14 stores in advance travel trajectory data indicating the travel trajectory of a mobile object, such as a vehicle, having an MMS mounted thereon, for example. Herein, the travel trajectory data is data represented by a two-dimensional line segment on the coordinate system of the map data, for example.

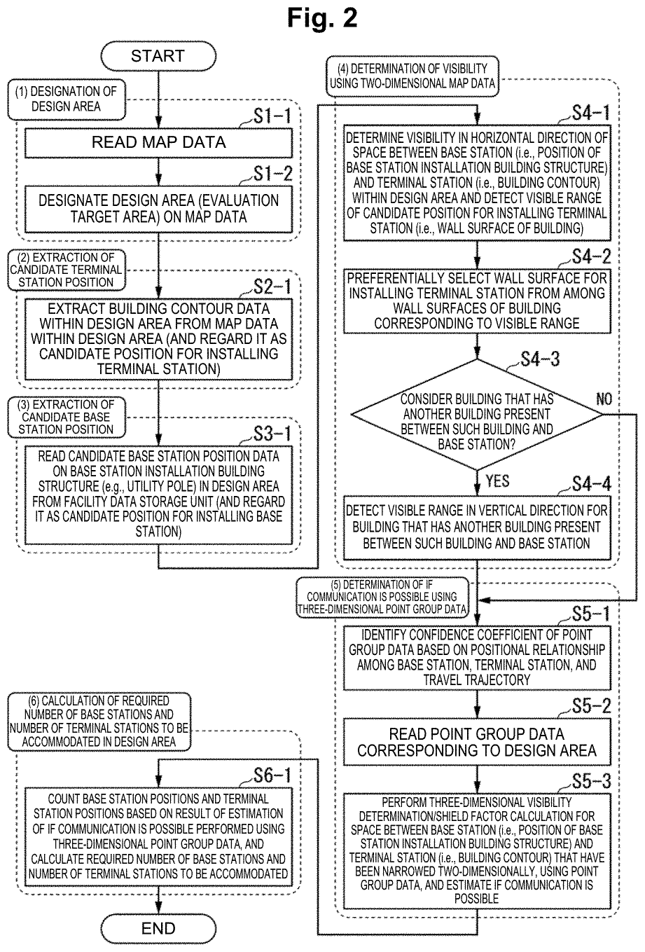

Hereinafter, the configuration of each functional unit of the station deployment support apparatus 1 as well as a process flow of a station deployment support method performed by the station deployment support apparatus 1 will be described with reference to a flowchart illustrated in FIG. 2.

The design area designation unit 2 reads the two-dimensional map data from the map data storage unit 11 (step S1-1). The design area designation unit 2 writes and stores the read map data into a working memory, for example. The design area designation unit 2 selects a rectangular area on the map data stored in the working memory based on a designation signal designating the range of a design area output from the operation processing unit 10 in response to an operation of the user of the station deployment support apparatus 1, for example. The design area designation unit 2 designates the selected area as a design area (step S1-2).

The candidate terminal station position extraction unit 4 extracts, for each building, building contour data, which indicates the position and the shape of the building, from the map data within the design area (step S2-1). The building contour data extracted by the candidate terminal station position extraction unit 4 is data indicating a wall surface of the building on which a terminal station may possibly be installed, and thus is regarded as a candidate position for installing a terminal station.

The candidate terminal station position extraction unit 4 generates building identification data, which is identification information capable of uniquely identifying each individual building, and provides the data to the extracted building contour data on each building. The candidate terminal station position extraction unit 4 associates the thus provided building identification data with the building contour data corresponding to the building, and outputs the resulting data.

The candidate base station position extraction unit 3 reads from the facility data storage unit 12 candidate two-dimensional base station position data corresponding to a base station installation building structure located in the design area designated by the design area designation unit 2, and outputs the read data (step S3-1). It should be noted that when the coordinates of the map data stored in the map data storage unit 11 do not coincide with the coordinates of the candidate two-dimensional base station position data stored in the facility data storage unit 12, the candidate base station position extraction unit 3 converts the coordinates of the read candidate two-dimensional base station position data into the coordinate system of the map data.

The two-dimensional visibility determination processing unit 5 performs, for each piece of the candidate two-dimensional base station position data output from the candidate base station position extraction unit 3, determination of whether each building is visible in the horizontal direction from the position indicated by each piece of the candidate two-dimensional base station position data, based on the building contour data on each building output from the candidate terminal station position extraction unit 4, using a means disclosed in Reference 1 (Japanese Patent Application No. 2019-004727), for example. The two-dimensional visibility determination processing unit 5 detects as the visible range the range of the building that has been determined to be visible, that is, wall surfaces of the building (step S4-1).

The two-dimensional visibility determination processing unit 5 further preferentially selects, from among the wall surfaces of the building corresponding to the detected visible range, a candidate wall surface of the building for installing a terminal station. When the visible range of a given building includes a plurality of wall surfaces, for example, the two-dimensional visibility determination processing unit 5 preferentially determines a wall surface closer to the base station as a wall surface for installing a terminal station, and selects such a wall surface as a final visible range in the horizontal direction.

It should be noted that when the visible range of a given building includes a plurality of wall surfaces, the method of selecting a wall surface is not limited to the aforementioned method and may be any method. For example, selection may be performed based on the value of a confidence coefficient described below.

The two-dimensional visibility determination processing unit 5 associates, for each candidate base station position, the building contour data on the building having the detected visible range in the horizontal direction with data indicating the visible range in the horizontal direction of the building, and writes and stores the resulting data into the two-dimensional visibility determination result storage unit 15 (step S4-2). Accordingly, building identification data on a building as well as data indicating the visible range in the horizontal direction of the building corresponding to the building identification data is stored in the two-dimensional visibility determination result storage unit 15 for each piece of candidate two-dimensional base station position data.

The two-dimensional visibility determination processing unit 5 determines the presence or absence of an instruction signal, which indicates “an instruction to consider a building that has another building present between such building and the candidate base station position,” output from the operation processing unit 10 in response to an operation of the user of the station deployment support apparatus 1 (step S4-3). It should be noted that the user of the station deployment support apparatus 1 has selected in advance whether to consider a building that has another building present between such building and the candidate base station position before the process in FIG. 2 is started, and if the user has selected to consider such building, the operation processing unit 10 outputs an instruction signal indicating “an instruction to consider a building that has another building present between such building and the candidate base station position” in response to an operation of the user.

If the two-dimensional visibility determination processing unit 5 determines that such an instruction signal is not received (step S4-3, No), the process proceeds to step S5-1. Meanwhile, if the two-dimensional visibility determination processing unit 5 determines that such an instruction signal is received (step S4-3, Yes), the process proceeds to step S4-4.

The two-dimensional visibility determination processing unit 5 detects, for each piece of candidate two-dimensional base station position data, a building that has another building present between such building and the position indicated by the candidate two-dimensional base station position data, as a target building for which visibility in the vertical direction is to be detected, among buildings within the design area. For example, the two-dimensional visibility determination processing unit 5 refers to the two-dimensional visibility determination result storage unit 15, and, for each piece of candidate two-dimensional base station position data, determines a building without the visible range detected in the horizontal direction as a building that has another building present such building and the position indicated by the candidate two-dimensional base station position data, and thus detects the building as a target building for which visibility in the vertical direction is to be detected (hereinafter, a target building for which visibility in the vertical direction is to be detected shall also be referred to as a “visibility-detection-target building”).

The two-dimensional visibility determination processing unit 5, in response to an operation of the user of the station deployment support apparatus 1, captures from the outside data indicating the installation altitude for each candidate base station position designated by the user as well as data indicating the height of each building, for example.

The two-dimensional visibility determination processing unit 5 performs, for each visibility-detection-target building for each detected candidate base station position, detection of the visible range in the vertical direction from the height of the installation altitude at the candidate base station position, using the captured data indicating the height of the building. The two-dimensional visibility determination processing unit 5 associates the building identification data on the building having the detected visible range in the vertical direction with data indicating the detected visible range in the vertical direction of the building, and writes and stores the resulting data into the two-dimensional visibility determination result storage unit 15 (step S4-4). Accordingly, building identification data on a building as well as data indicating the visible range in the horizontal and vertical directions of the building corresponding to the building identification data is stored in the two-dimensional visibility determination result storage unit 15 for each piece of candidate two-dimensional base station position data.

The candidate three-dimensional position selection unit 20 in the point group data processing unit 6 selects a candidate base station position indicating a candidate position for installing a base station in a three-dimensional space, and a candidate terminal station position indicating a candidate position for installing a terminal station in the three-dimensional space.

For example, the user of the station deployment support apparatus 1 operates the operation processing unit 10 to select one piece of candidate two-dimensional base station position data from the two-dimensional visibility determination result storage unit 15. The operation processing unit 10 outputs the selected candidate two-dimensional base station position data to the candidate three-dimensional position selection unit 20. The candidate three-dimensional position selection unit 20 captures the candidate two-dimensional base station position data output from the operation processing unit 10. The candidate three-dimensional position selection unit 20 acquires from the point group data storage unit 13 point group data around the position indicated by the captured candidate two-dimensional base station position data, and displays the acquired point group data on a screen. The user operates the operation processing unit 10 to select a candidate three-dimensional position for installing a base station from among the pieces of point group data displayed on the screen, and output the selected candidate three-dimensional position to the candidate three-dimensional position selection unit 20. The candidate three-dimensional position selection unit 20 captures the three-dimensional position output from the operation processing unit 10, and determines the captured three-dimensional position as the candidate three-dimensional base station position data.

Next, the candidate three-dimensional position selection unit 20 reads from the two-dimensional visibility determination result storage unit 15 data indicating the visible range of the building associated with the captured candidate two-dimensional base station position data. The candidate three-dimensional position selection unit 20 reads from the point group data storage unit 13 point group data in the range indicated by the read data indicating the visible range of the building, and displays the read point group data on the screen. The user operates the operation processing unit 10 to select a candidate three-dimensional position for installing a terminal station from among the pieces of point group data displayed on the screen, and output the selected candidate three-dimensional position to the candidate three-dimensional position selection unit 20. The candidate three-dimensional position selection unit 20 captures the three-dimensional position output from the operation processing unit 10, and determines the captured three-dimensional position as the candidate three-dimensional terminal station position data. Hereinafter, the candidate three-dimensional base station position data shall be simply referred to as “candidate base station position data,” and the candidate three-dimensional terminal station position data shall be simply referred to as “candidate terminal station position data.”

The positional relationship identification unit 21 performs, for each combination of the candidate base station position data and the candidate terminal station position data selected by the candidate three-dimensional position selection unit 20, generation of base station positional relationship identification data indicating the positional relationship between the travel trajectory and the candidate base station position, and terminal station positional relationship identification data indicating the positional relationship between the travel trajectory and the candidate terminal station position based on the travel trajectory data stored in the travel trajectory data storage unit 14.

The confidence coefficient identification unit 22 performs, based on the base station positional relationship identification data and the terminal station positional relationship identification data generated by the positional relationship identification unit 21, identification of a confidence coefficient indicating the degree of reliability of the processing result of a predetermined evaluation process performed based on the point group data. Herein, the predetermined evaluation process is a three-dimensional visibility determination process performed by the three-dimensional visibility determination processing unit 23 or a shield factor calculation process performed by the shield factor calculation unit 24.

The confidence coefficient identification unit 22 outputs the identified confidence coefficient together with a combination of the candidate base station position data and the candidate terminal station position data corresponding to the confidence coefficient (step S5-1). The confidence coefficient identification unit 22 can, by presenting the confidence coefficient to the user of the station deployment support apparatus 1, allow the user to recognize the degree of reliability of the processing result of a predetermined evaluation process for each combination of the candidate base station position and the candidate terminal station position.

The three-dimensional visibility determination processing unit 23 reads from the point group data storage unit 13 point group data of a space between the candidate base station position and the candidate terminal station position respectively indicated by the candidate base station position data and the candidate terminal station position data selected by the candidate three-dimensional position selection unit 20 (step S5-2). Then, the three-dimensional visibility determination processing unit 23 performs a three-dimensional visibility determination process for the space between the candidate base station position and the candidate terminal station position based on the read point group data, using a means disclosed in Reference 2 (Japanese Patent Application No. 2019-001401), for example, and estimates if communication is possible based on the result of the determination process (step S5-3).

In contrast, when the point group data processing unit 6 calculates the shield factor, the shield factor calculation unit 24 reads from the point group data storage unit 13 point group data of the space between the candidate base station position and the candidate terminal station position respectively indicated by the candidate base station position data and the candidate terminal station position data selected by the candidate three-dimensional position selection unit 20 (step S5-2). Then, the shield factor calculation unit 24 calculates the shield factor of the space between the candidate base station position and the candidate terminal station position based on the read point group data, using a means disclosed in Reference 3 (Japanese Patent Application No. 2019-242831), for example, and estimates if communication is possible based on the result of the calculation process (step S5-3). The point group data processing unit 6 performs the process of steps S5-1 to S5-3 for all combinations of the candidate base station position data and the candidate terminal station position data.

The number-of-stations calculation unit 7 counts the candidate base station positions and the candidate terminal station positions based on the result of estimation of if communication is possible, which has been performed by the point group data processing unit 6 using the three-dimensional point group data, and calculates the required number of base stations and the number of terminal stations to be accommodated for each candidate base station position (step S6-1).

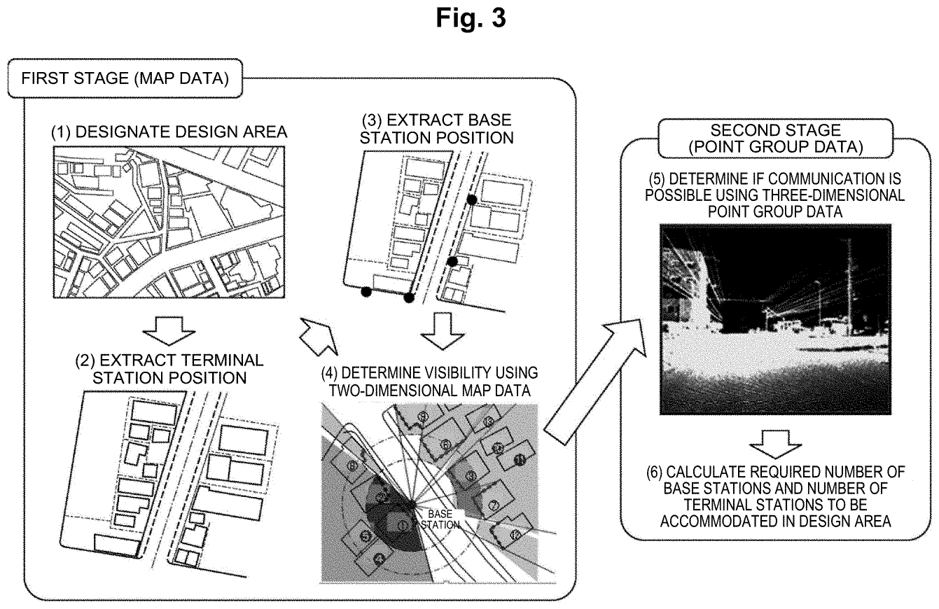

The configuration of the process performed by the station deployment support apparatus 1 can also be regarded as a two-stage process that includes a process performed using map data as two-dimensional data, and a process performed using point group data as three-dimensional data in response to the result of the first-stage process as illustrated in FIG. 3.

As illustrated in FIG. 3, the first-stage process performed using map data as two-dimensional data includes four processes: (1) designating a design area, (2) extracting a candidate terminal station position, (3) extracting a candidate base station position, and (4) determining visibility using the two-dimensional map data.

The process (1) of designating a design area corresponds to the process of steps S1-1 and S1-2 performed by the design area designation unit 2. The process (2) of extracting a candidate terminal station position corresponds to the process of step S2-1 performed by the candidate terminal station position extraction unit 4. The process (3) of extracting a candidate base station position corresponds to the process of step S3-1 performed by the candidate base station position extraction unit 3. The process (4) of determining visibility using the two-dimensional map data corresponds to the process of steps S4-1 to S4-4 performed by the two-dimensional visibility determination processing unit 5.

The second-stage process performed using point group data as three-dimensional data includes two processes: (5) determining if communication is possible using three-dimensional point group data, and (6) calculating the required number of base stations and the number of terminal stations to be accommodated in the design area.

The process (5) of determining if communication is possible using three-dimensional point group data corresponds to the process of steps S5-1 to S5-3 performed by the point group data processing unit 6. The process (6) of calculating the required number of base stations and the number of terminal stations to be accommodated in the design area corresponds to the process of step S6-1 performed by the number-of-stations calculation unit 7.

For example, regarding a base station to be installed in an outdoor facility, such as a utility pole, and a terminal station to be installed on a wall surface of a building for performing millimeter-wave wireless communication, it is possible to support the station deployment design by determining the three-dimensional visibility of a space between a candidate base station position and a candidate terminal station position using three-dimensional point group data. To handle three-dimensional point group data, an enormous volume of data and enormous computer resources are needed. Therefore, the station deployment support apparatus 1 is configured such that before the three-dimensional point group data is utilized, the two-dimensional visibility determination processing unit 5 determines the two-dimensional visibility of a space between a candidate base station position and a candidate terminal station position, and the point group data processing unit 6 narrows the point group data to be utilized using the result of the determination so as to perform a three-dimensional visibility determination process. Therefore, it is possible to perform an efficient three-dimensional visibility determination process with reduced computer resources.

For wireless communication, it is important to not only determine simple linear visibility, but also calculate the “shield factor” of a spheroidal region, that is, a so-called Fresnel zone between transmission and reception related to the propagation of radio waves through a space. The point group data processing unit 6 in the station deployment support apparatus 1 includes the shield factor calculation unit 24 to calculate the shield factor. For calculation of the shield factor, more computer resources are needed than those for a three-dimensional visibility determination process. However, since the point group data to be utilized has been sufficiently narrowed through the two-dimensional visibility determination process performed by the two-dimensional visibility determination processing unit 5 in the station deployment support apparatus 1, it is possible to perform an efficient shield factor calculation process with reduced computer resources.

In the station deployment support apparatus 1 of the first embodiment, the positional relationship identification unit 21 performs, based on travel trajectory data indicating the travel trajectory of a mobile object that travels and measures an object present in a three-dimensional space within a predetermined measurable distance, and then acquires point group data indicating the position of the measured object in the three-dimensional space, the measurable distance, candidate base station position data indicating a candidate position for installing a base station apparatus, and candidate terminal station position data indicating a candidate position for installing a terminal station apparatus, generation of base station positional relationship identification data that indicates the positional relationship between the travel trajectory and the candidate base station position, and terminal station positional relationship identification data that indicates the positional relationship between the travel trajectory and the candidate terminal station position. The confidence coefficient identification unit 22 is configured to, based on the base station positional relationship identification data and the terminal station positional relationship identification data generated by the positional relationship identification unit 21, identify a confidence coefficient indicating the degree of reliability of the processing result of a predetermined evaluation process performed based on the point group data.

Accordingly, the confidence coefficient identification unit 22 can present to the user the confidence coefficient indicating the degree of reliability of the processing result of a predetermined evaluation process performed based on the point group data, for each candidate base station position and each candidate terminal station position. Therefore, when not all pieces of point group data have been acquired from the space between the candidate base station position and the candidate terminal station position, the reliability of the point group data is low, and in such a case, it is possible to allow the user to recognize from the confidence coefficient that the reliability of the processing result of a predetermined evaluation process performed using such point group data is also low.

For example, suppose that not all pieces of point group data have been acquired, but the three-dimensional visibility determination processing unit 23 indicates “visible” as a result of a determination process or the shield factor calculation unit 24 indicates “a sufficiently low shield factor that meets the requirement for wireless communication” as a result of a calculation process. Even in such a case, it is possible to urge the user to take precautions by presenting a confidence coefficient with a small value. Accordingly, it is possible to prevent the user from making erroneous determination, for example, selecting candidate positions for installing a base station and a terminal station in a space from which point group data, which serves as a basis for three-dimensional visibility determination or shield factor calculation, has not been acquired.

In addition, identifying the confidence coefficient can prompt the user to make the following determination depending on whether the value of the confidence coefficient is large or small. For example, suppose that not all pieces of point group data have been acquired from the space between the candidate base station position and the candidate terminal station position, but the value of the confidence coefficient is large. In such a case, it is possible to prompt the user to, regarding the combination of the candidate base station position and the candidate terminal station position to be considered, determine that consideration using the acquired point group data is possible.

Further, identifying the confidence coefficient can also allow the three-dimensional visibility determination processing unit 23 to determine whether to perform a three-dimensional visibility determination process or allow the shield factor calculation unit 24 to determine whether to calculate the shield factor depending on whether the value of the confidence coefficient is large or small. For example, the three-dimensional visibility determination processing unit 23 or the shield factor calculation unit 24 may be configured to, when the value of the confidence coefficient is small, not perform a process for a combination of the candidate base station position and the candidate terminal station position as the processing targets, so that the amount of calculation can be reduced. Further, when the user is notified of the fact that the three-dimensional visibility determination processing unit 23 or the shield factor calculation unit 24 has not performed a process, the user can be prompted to acquire point group data again from the space between the candidate base station position and the candidate terminal station position as the processing targets or reconsider the candidate base station position and the candidate terminal station position. Therefore, even when the state of acquisition of point group data from the space between the candidate base station position and the candidate terminal station position is not good, the user can perform appropriate station deployment design.

### Second Embodiment

Hereinafter, a second embodiment of the present invention will be described with reference to the drawings.

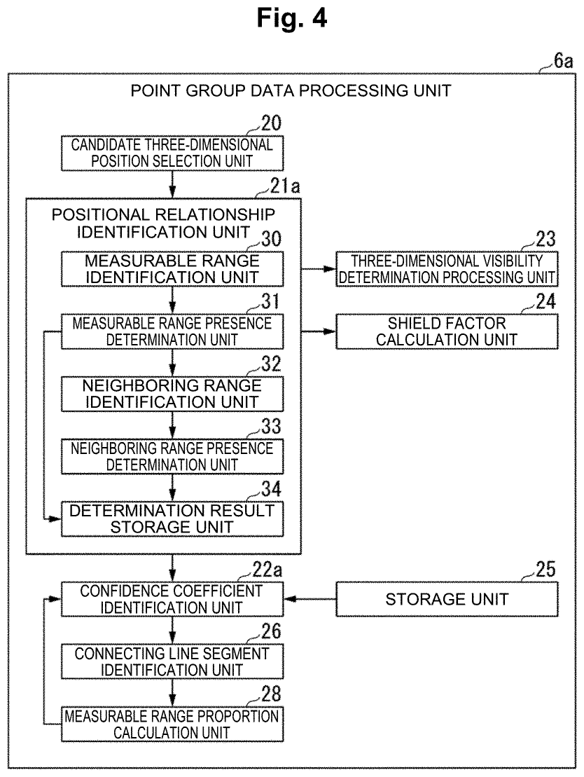

FIG. 4 is a block diagram illustrating the internal configuration of a point group data processing unit 6a applied to the second embodiment. In the second embodiment, components identical to those of the first embodiment are denoted by identical reference signs. In the following description, a station deployment support apparatus of the second embodiment shall be referred to as a station deployment support apparatus 1a with a reference sign “1a” added thereto, though not illustrated in the drawings. The station deployment support apparatus 1a has a configuration obtained by replacing the point group data processing unit 6 in the station deployment support apparatus 1 of the first embodiment with the point group data processing unit 6a illustrated in FIG. 4.

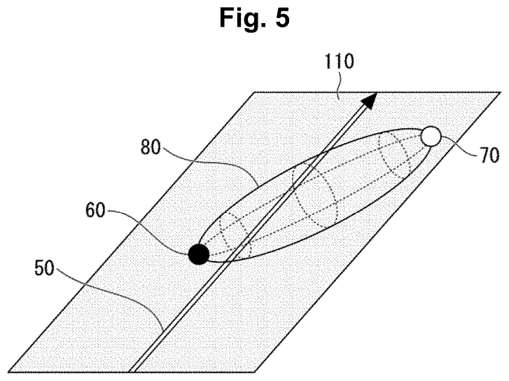

First, the relevance of a confidence coefficient identified in the second embodiment to the positional relationship among the travel trajectory of a mobile object, such as a vehicle, having an MMS mounted thereon, a candidate base station position, and a candidate terminal station position will be described with reference to FIGS. 5 to 14.

In FIG. 5, an arrowed line segment indicated by reference sign 50 is the travel trajectory indicated by the travel trajectory data stored in the travel trajectory data storage unit 14, and indicates that a mobile object, such as a vehicle, having an MMS mounted thereon has traveled in the direction of the arrow. The MMS irradiates a surrounding space with a laser radar beam to measure the reflection of the laser radar beam from the object, and then records data on the direction in which the object is present as well as the distance from the object. Point group data is generated through the operation of converting the recorded data on the direction and the distance into the coordinates of the three-dimensional space. Herein, there is a limitation on the distance within which data on the direction and the distance can be obtained with a laser radar beam emitted from the MMS, and such a limitation is referred to as a measurable distance. The measurable distance is the distance determined by the performance of the MMS and is a known value.

A planar region indicated by reference sign 110 is a region indicating the measurable range of a laser radar beam emitted from the MMS for measurement purposes, and is a region having, on the opposite sides of the line segment of the travel trajectory 50 as the center, areas each corresponding to the length of the measurable distance of the MMS. Hereinafter, such a region shall be referred to as a measurable range 110.

In FIG. 5, a candidate base station position 60 indicated by candidate base station position data and a candidate terminal station position 70 indicated by candidate terminal station position data are located on the opposite sides of the travel trajectory 50, and both the candidate base station position 60 and the candidate terminal station position 70 are included in a space obtained by expanding the measurable range 110 in the vertical direction. In other words, both the candidate base station position 60 on the two-dimensional plane for which the vertical coordinate components are ignored and the candidate terminal station position 70 on the two-dimensional plane for which the vertical coordinate components are ignored are located within the measurable range 110.

It should be noted that in practice, a space in a sphere that has the MMS as the center and has the measurable distance as the radius corresponds to the measurable range. In addition, regarding an MMS that moves straight, a space in a cylinder that has the travel trajectory 50 as the center and has the measurable distance as the radius corresponds to the measurable range. However, usually, any of such measurable ranges has a measurable distance with a sufficiently large value in the horizontal direction in comparison with the altitude at which a base station apparatus is installed (on a utility pole, for example) and the altitude at which a terminal station apparatus is installed (on a wall surface of a building). Therefore, when the candidate base station position 60 and the candidate terminal station position 70 on the two-dimensional plane for which the vertical coordinate components are ignored are located within the measurable range 110, it follows that the candidate base station position 60 and the candidate terminal station position 70 are also located within the measurable range in the three-dimensional space.

Hereinafter, the fact that the candidate base station position 60 or the candidate terminal station position 70 is included in the space obtained by expanding the measurable range 110 in the vertical direction is referred to as follows: “the candidate base station position 60 or the candidate terminal station position 70 is located within the measurable range 110.” In contrast, the fact that the candidate base station position 60 or the candidate terminal station position 70 is not included in the space obtained by expanding the measurable range 110 in the vertical direction is referred to as follows: “the candidate base station position 60 or the candidate terminal station position 70 is located outside the measurable range 110.”

A spheroid indicated by reference sign 80 is a Fresnel zone representing a region in which radio waves propagate. The Fresnel zone is formed when a wireless communication device is installed at each of the candidate base station position 60 and the candidate terminal station position 70. When there is any point group data in the Fresnel zone 80, it is highly probable that such a zone is determined to be not visible. In addition, the shield factor becomes high.

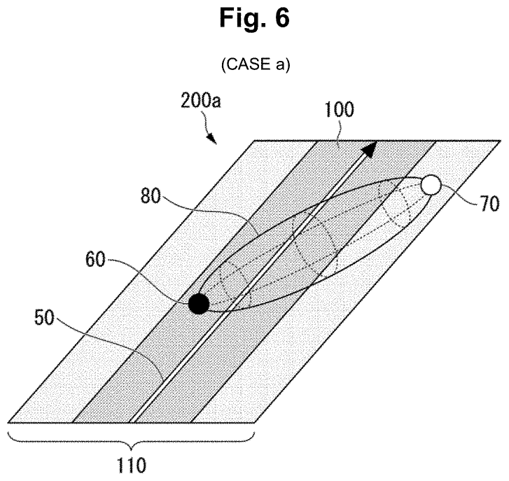

FIG. 6 is a view obtained by adding a planar region indicated by reference sign 100 to FIG. 5. The planar region indicated by reference sign 100 is a region having, on the opposite sides of the line segment of the travel trajectory 50 as the center, areas each corresponding to the length of the neighbor distance determined in advance that is shorter than the measurable distance of the MMS determined in advance. Hereinafter, such a region shall be referred to as a neighboring range 100. For example, the neighbor distance may be determined in advance as a length corresponding to about half the width of a road in the evaluation target range on which a mobile object, such as a vehicle, having an MMS mounted thereon travels.

As illustrated in FIG. 6, the candidate base station position 60 is included in a space obtained by expanding the neighboring range 100 in the vertical direction. In contrast, the candidate terminal station position 70 is not included in the space obtained by expanding the neighboring range 100 in the vertical direction. In other words, the candidate base station position 60 on the two-dimensional plane for which the vertical coordinate components are ignored is located within the neighboring range 100. Meanwhile, the candidate terminal station position 70 on the two-dimensional plane for which the vertical coordinate components are ignored is located outside the neighboring range 100.

Hereinafter, the fact that the candidate base station position 60 or the candidate terminal station position 70 is included in the space obtained by expanding the neighboring range 100 in the vertical direction is referred to as follows: “the candidate base station position 60 or the candidate terminal station position 70 is located within the neighboring range 100.” In contrast, the fact that the candidate base station position 60 or the candidate terminal station position 70 is not included in the space obtained by expanding the neighboring range 100 in the vertical direction is referred to as follows: “the candidate base station position 60 or the candidate terminal station position 70 is located outside the neighboring range 100.”

As illustrated in FIG. 6, a case where both the candidate base station position 60 and the candidate terminal station position 70 are located within the measurable range 110 shall be hereinafter referred to as a “case a,” and the positional relationship of the “case a” shall be hereinafter referred to as a positional relationship configuration 200a.

In the “case a,” both the candidate base station position 60 and the candidate terminal station position 70 are located within the measurable range 110. Therefore, it is considered that all pieces of point group data in the space between the candidate base station position 60 and the candidate terminal station position 70 can be acquired unless some are missed during the measurement process. Therefore, it is estimated that the processing result of a three-dimensional visibility determination process of the three-dimensional visibility determination processing unit 23 and the processing result of a shield factor calculation process of the shield factor calculation unit 24, each performed based on the acquired point group data, are high reliable. Thus, it is considered that it makes sense to perform such a process with the three-dimensional visibility determination processing unit 23 or the shield factor calculation unit 24.

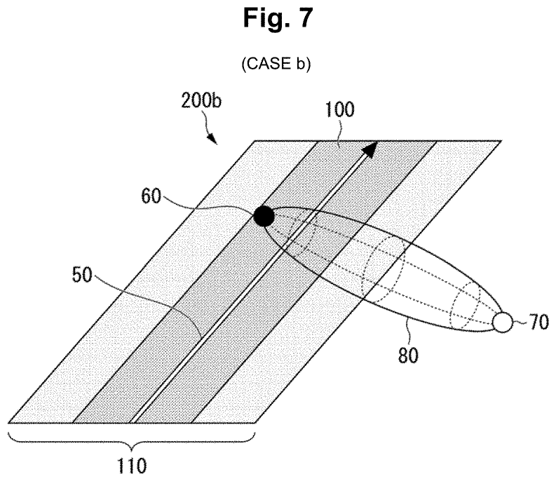

In a “case b” indicated by a positional relationship configuration 200b illustrated in FIG. 7, the candidate base station position 60 is located within the measurable range 110 and the neighboring range 100, while the candidate terminal station position 70 is located outside the measurable range 110. In this manner, when one of the candidate base station position 60 and the candidate terminal station position 70 is located outside the measurable range 110, some pieces of point group data in the space between the two wireless stations cannot be acquired. In such a case, it is estimated that the processing result of a three-dimensional visibility determination process or the processing result of a shield factor calculation process is less reliable than in the “case a.”

However, even in the “case b,” when the processing result of a three-dimensional visibility determination process performed by the three-dimensional visibility determination processing unit 23 based on the acquired point group data indicates “not visible” or when the processing result of a shield factor calculation process performed by the shield factor calculation unit 24 based on the acquired point group data indicates a “high shield factor,” such a result actually serves as reference information for the user to determine that the propagation environment is not better than the obtained result. Therefore, although there is a need to warn the user about low reliability, it is considered that it makes some sense to perform the aforementioned process with the three-dimensional visibility determination processing unit 23 or the shield factor calculation unit 24.

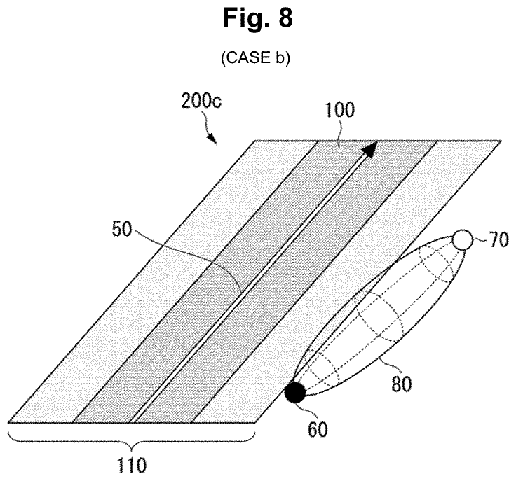

In a “case c” of a positional relationship configuration 200c illustrated in FIG. 8, both the candidate base station position 60 and the candidate terminal station position 70 are located outside the measurable range 110. In such a case, it is impossible to acquire point group data from the space between the candidate base station position 60 and the candidate terminal station position 70. Therefore, it is nonsense to perform a three-dimensional visibility determination process of the three-dimensional visibility determination processing unit 23 or a shield factor calculation process of the shield factor calculation unit 24 that should be performed based on point group data. Even if such a process is performed, it is estimated that the obtained processing result has quite low reliability. Therefore, in the “case c,” it is considered desirable not to perform a process with the three-dimensional visibility determination processing unit 23 or the shield factor calculation unit 24 and to present to the user information indicating “process impossible” such as “visibility determination impossible” or “shield factor calculation impossible.”

As described with reference to the three cases of the “case a” to the “case c” illustrated in FIGS. 6 to 8, the state of acquisition of point group data, which is present in the space between the candidate base station position 60 and the candidate terminal station position 70, differs from case to case. Thus, the reliability of the acquired point group data also differs from case to case. In this manner, since point group data with difference reliability is utilized, the reliability of the processing result of a three-dimensional visibility determination process or a shield factor calculation process for the space between the candidate base station position 60 and the candidate terminal station position 70 also differs depending on the reliability of the point group data.

Therefore, when the degree of reliability of the pressing result of a predetermined evaluation process performed based on the acquired point group data is presented to the user of the station deployment support apparatus 1a in an easily understandable way using a confidence coefficient, the processing result of the predetermined evaluation process can be actually utilized for installing a base station and a terminal station if the confidence coefficient has a large value, for example. In contrast, if the confidence coefficient has a small value, it is possible to prompt the user to acquire point group data again or reconsider the positions of the candidate base station position 60 and the candidate terminal station position 70.

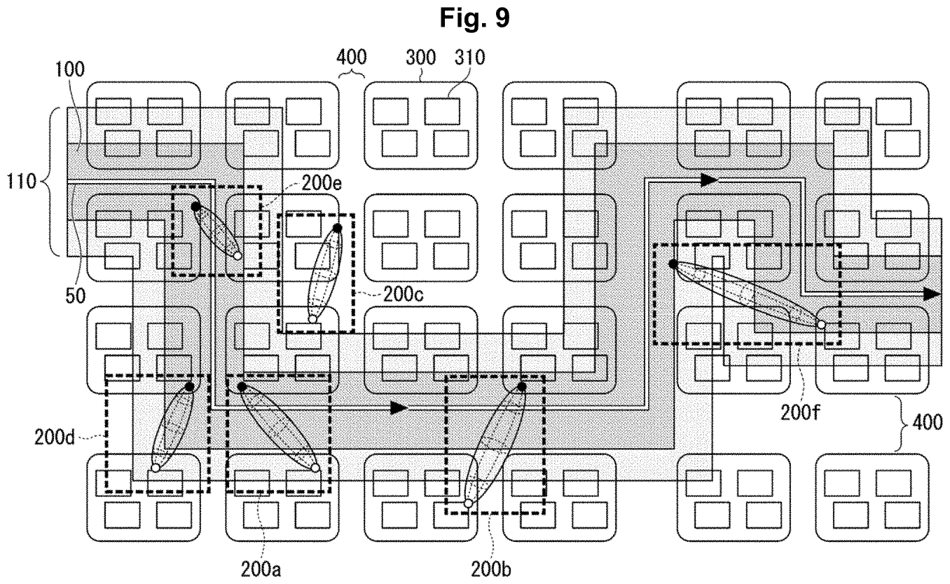

The reliability of point group data is determined by the positional relationship among the candidate base station position 60, the candidate terminal station position 70, and the travel trajectory 50. FIG. 9 illustrates a case where the reliability of point group data is different other than the three cases illustrated in FIGS. 6 to 8.

FIG. 9 is a view representing a map of an urban area. A region of a road 400 is illustrated in a lattice pattern. Each of a plurality of regions partitioned in a lattice pattern by the regions of the road 400 is a site 300. Each site 300 includes a plurality of buildings 310 indicated by a rectangular shape.

FIG. 9 also illustrates the travel trajectory 50 of a mobile object, such as a vehicle, having an MMS mounted thereon, and the neighboring range 100 and the measurable range 110 are illustrated along the travel trajectory 50. As seen in FIG. 9, the measurable range 110 does not cover the entire urban area.

FIG. 9 also illustrates the “case a” represented by the positional relationship configuration 200a illustrated in FIG. 6, the “case b” represented by the positional relationship configuration 200b illustrated in FIG. 7, and the “case c” represented by the positional relationship configuration 200c illustrated in FIG. 8. FIG. 9 further illustrates, in addition to such three cases, a “case d” represented by a positional relationship configuration 200d, a “case e” represented by a positional relationship configuration 200e, and a “case f” represented by a positional relationship configuration 200f.

In the “case d,” both the candidate base station position 60 and the candidate terminal station position 70 are located within the measurable range 110, and the candidate base station position 60 is further located within the neighboring range 100. When the “case d” and the “case a” are compared, the “case d” differs from the “case a” in that the candidate base station position 60 indicated by a solid circle “●” and the candidate terminal station position 70 indicated by a hollow circle “∘” that are included in the positional relationship configuration 200d are present on one side of the travel trajectory 50.

In the “case e,” both the candidate base station position 60 indicated by a solid circle “●” and the candidate terminal station position 70 indicated by a hollow circle “∘” that are included in the positional relationship configuration 200e are located within the neighboring range 100. Therefore, the Fresnel zone 80 is also located within the neighboring range 100. Thus, in the “case e,” it is considered that point group data with further higher reliability than that in the “case a” can be acquired. Thus, in the “case e,” it can be estimated that the processing result of a three-dimensional visibility determination process of the three-dimensional visibility determination processing unit 23 and the processing result of a shield factor calculation process of the shield factor calculation unit 24, each performed based on the acquired point group data, have further higher reliability than in the “case a.”

In the “case f,” both the candidate base station position 60 indicated by a solid circle “●” and the candidate terminal station position 70 indicated by a hollow circle “∘” that are included in the positional relationship configuration 200f are located within the neighboring range 100 as in the “case e.” However, the “case f” differs from the “case e” in that a part of the Fresnel zone 80 is located neither within the neighboring range 100 nor within the measurable range 110. Therefore, in the “case f,” it is considered that the reliability of the point group data that can be acquired is lower than that in the “case e.” Thus, in the “case f,” it can be estimated that the processing result of a three-dimensional visibility determination process of the three-dimensional visibility determination processing unit 23 and the processing result of a shield factor calculation process of the shield factor calculation unit 24, each performed based on the acquired point group data, is less reliable than in the “case e.”

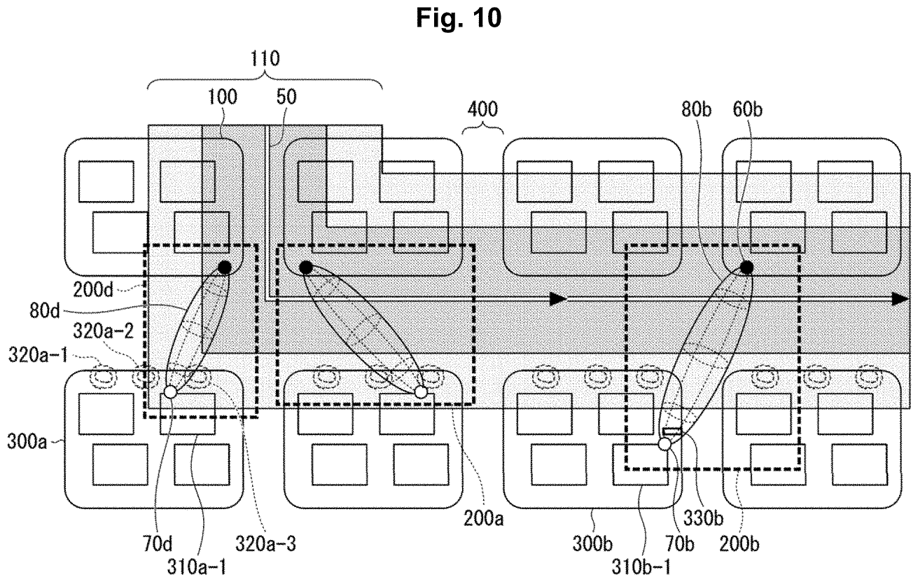

Next, referring to FIG. 10, further consideration of the reliability of point group data will be described using the “case b” and the “case d.” FIG. 10 is an enlarged view of a region including the positional relationship configuration 200a, the positional relationship configuration 200b, and the positional relationship configuration 200d in FIG. 9. It should be noted that FIG. 10 illustrates not only the enlarged view of FIG. 9 but also trees 320a-1 to 320a-3, a signboard 330b, and the like that are omitted in FIG. 9.

It should be noted that in FIGS. 10 to 12, to illustrate the candidate base station position 60, the candidate terminal station position 70, and the Fresnel zone 80 for each case, reference signs “b” and “d” of the “case b” and the “case d” are added to their reference signs. In addition, to distinguish among the sites 300 and the buildings 310, different alphabetical characters or branch numbers are added thereto for convenience's sake.

As described above, in the “case b,” the candidate base station position 60b is located within the measurable range 110 and the neighboring range 100. The candidate terminal station position 70b is located on a wall surface of a building 310b-1 in a site 300b, and such a position is outside the measurable range 110. Point group data has not been acquired outside the measurable range 110. As illustrated in FIG. 10, the signboard 330b, which has a shop name and the like printed thereon, is present near the candidate terminal station position 70b and at a position shielding the Fresnel zone 80b. Since the signboard 330b is not located within the measurable range 110, point group data on the signboard 330b has not been acquired.

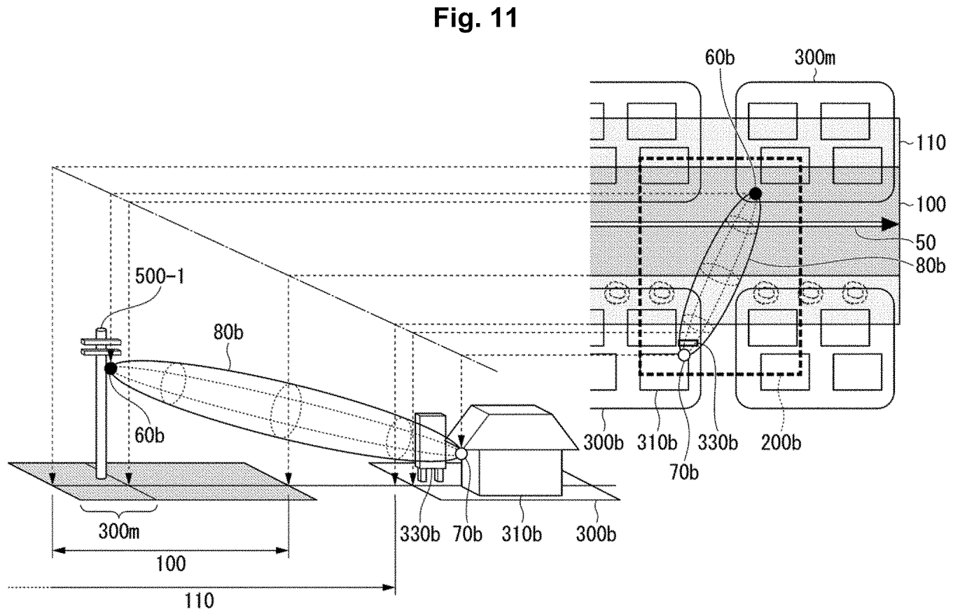

FIG. 11 illustrates a plan view of a region including the positional relationship configuration 200b illustrated in FIG. 10, and a bird's-eye view illustrating the region three-dimensionally. In the plan view and the bird's-eye view, corresponding objects, positions, and the like are denoted by identical reference signs. As seen in FIG. 11, the signboard 330b is located at a position shielding the Fresnel zone 80b and at a position outside the measurable range 110. In such a case, the acquired point group data does not include the point group data on the signboard 330b. Thus, in a three-dimensional visibility determination process performed by the three-dimensional visibility determination processing unit 23, erroneous determination of “being visible” may be made. In addition, in a shield factor calculation process performed by the shield factor calculation unit 24, a “low shield factor” may be obtained. In such a case, the user of the station deployment support apparatus 1a may make erroneous determination.

Meanwhile, suppose that a processing result of “being not visible” is obtained in a three-dimensional visibility determination process performed by the three-dimensional visibility determination processing unit 23 based on the acquired point group data or a processing result of a “high shield factor” is obtained in a shield factor calculation process performed by the shield factor calculation unit 24 based on the acquired point group data. In such a case, it can be said that the obtained processing result is a correct processing result. In this regard, even in the “case b,” it can be said that the processing result of a three-dimensional visibility determination process and the processing result of a shield factor calculation process have passable reliability.

In the “case d” represented by the positional relationship configuration 200d illustrated in FIG. 10, the candidate terminal station position 70d is located on a wall surface of a building 310a-1, and a site 300a of the building 310a-1 is planted with trees 320a-1, 320a-2, and 320a-3, such as roadside trees or garden trees. Among them, the tree 320a-3 is located at a position shielding the Fresnel zone 80d between the candidate base station position 60d and the candidate terminal station position 70d.

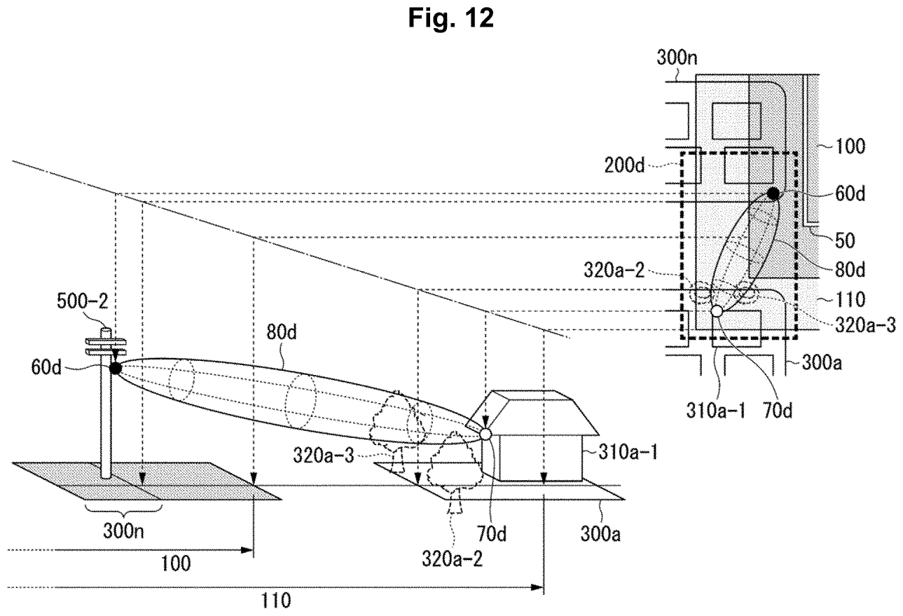

FIG. 12 illustrates a plan view of a region including the positional relationship configuration 200d illustrated in FIG. 10, and a bird's-eye view illustrating the region three-dimensionally. In the plan view and the bird's-eye view, corresponding objects, positions, and the like are denoted by identical reference signs. As seen in FIG. 12, the tree 320a-3 is located at a position shielding the Fresnel zone 80d and within the measurable range 110. Since the tree 320a-3 is located within the measurable range 110, point group data thereon has been acquired.

Typically, point group data on a tree, in particular, point group data on portions of branches and leaves of a tree include many gaps. For example, the thickness of leaves is about several [mm], while the interval of acquisition of point group data when a tree is not near the travel trajectory 50 is several [cm] to several tens of [cm], for example. Therefore, the acquired point group data on the tree includes many gaps depending on the density of branches and leaves of the tree.

When the three-dimensional visibility determination processing unit 23 performs a three-dimensional visibility determination process based on point group data including many gaps, a processing result of “being visible” may be obtained. In addition, when the shield factor calculation unit 24 performs a shield factor calculation process based on point group data including many gaps, a processing result of a “low shield factor” may be obtained. In such cases, the user of the station deployment support apparatus 1a may make erroneous determination.

Meanwhile, suppose that a processing result of “being not visible” is obtained in a three-dimensional visibility determination process performed by the three-dimensional visibility determination processing unit 23 based on the acquired point group data, or a processing result of a “high shield factor” is obtained in a shield factor calculation process performed by the shield factor calculation unit 24 based on the acquired point group data. In such a case, it can be said that the obtained processing result is a correct processing result. In this regard, even in the “case d,” it can be said that the processing result of a three-dimensional visibility determination process and the processing result of a shield factor calculation process have passable reliability.

Herein, referring again to FIG. 4, the configuration of the point group data processing unit 6a of the second embodiment will be described. The point group data processing unit 6a includes the candidate three-dimensional position selection unit 20, the positional relationship identification unit 21a, the confidence coefficient identification unit 22a, the three-dimensional visibility determination processing unit 23, the shield factor calculation unit 24, a storage unit 25, a connecting line segment identification unit 26, and a measurable range proportion calculation unit 28.

The positional relationship identification unit 21a includes a measurable range identification unit 30, a measurable range presence determination unit 31, a neighboring range identification unit 32, a neighboring range presence determination unit 33, and a determination result storage unit 34. In the positional relationship identification unit 21a, the measurable range identification unit 30 generates measurable range data indicating the measurable range 110 based on the travel trajectory data stored in the travel trajectory data storage unit 14 and the measurable distance determined in advance.

The measurable range presence determination unit 31 determines if the candidate base station position 60 is present within the measurable range 110 based on the measurable range data generated by the measurable range identification unit 30 and the candidate base station position data selected by the candidate three-dimensional position selection unit 20. Then, the measurable range presence determination unit 31 generates base station positional relationship identification data indicating the determination result. The base station positional relationship identification data includes information indicating that the candidate base station position 60 is present within the measurable range 110 or information indicating that the candidate base station position 60 is present outside the measurable range 110. Then, the measurable range presence determination unit 31 writes and stores the thus generated base station positional relationship identification data into the determination result storage unit 34.

In addition, the measurable range presence determination unit 31 determines if the candidate terminal station position 70 is present within the measurable range 110 based on the measurable range data generated by the measurable range identification unit 30 and the candidate terminal station position data selected by the candidate three-dimensional position selection unit 20. Then, the measurable range presence determination unit 31 generates terminal station positional relationship identification data indicating the determination result. The terminal station positional relationship identification data includes information indicating that the candidate terminal station position 70 is present within the measurable range 110 or information indicating that the candidate terminal station position 70 is present outside the measurable range 110. Then, the measurable range presence determination unit 31 writes and stores the thus generated terminal station positional relationship identification data into the determination result storage unit 34.

The neighboring range identification unit 32 generates neighboring range data indicating the neighboring range 100 based on the travel trajectory data stored in the travel trajectory data storage unit 14 and the neighbor distance determined in advance. The neighboring range presence determination unit 33 determines if the candidate base station position 60 is present within the neighboring range 100 based on the neighboring range data generated by the neighboring range identification unit 32 and the candidate base station position data selected by the candidate three-dimensional position selection unit 20. Then, the neighboring range presence determination unit 33 adds information indicating the determination result to the base station positional relationship identification data. That is, the neighboring range presence determination unit 33 adds to the base station positional relationship identification data stored in the determination result storage unit 34 information indicating that the candidate base station position 60 is present within the neighboring range 100 or information indicating that the candidate base station position 60 is present outside the neighboring range 100.

In addition, the neighboring range presence determination unit 33 determines if the candidate terminal station position 70 is present within the neighboring range 100 based on the neighboring range data generated by the neighboring range identification unit 32 and the candidate terminal station position data selected by the candidate three-dimensional position selection unit 20. Then, the neighboring range presence determination unit 33 adds information indicating the determination result to the terminal station positional relationship identification data. That is, the neighboring range presence determination unit 33 adds to the terminal station positional relationship identification data stored in the determination result storage unit 34 information indicating that the candidate terminal station position 70 is present within the neighboring range 100 or information indicating that the candidate terminal station position 70 is present outside the neighboring range 100.

The storage unit 25 stores a confidence coefficient calculation logic in advance. The confidence coefficient calculation logic is information for the confidence coefficient identification unit 22a to calculate and identify a confidence coefficient indicating the degree of reliability of the processing result of a predetermined evaluation process performed based on point group data. The predetermined evaluation process is, as described above, a three-dimensional visibility determination process performed by the three-dimensional visibility determination processing unit 23 or a shield factor calculation process performed by the shield factor calculation unit 24.

The confidence coefficient identification unit 22a identifies a confidence coefficient indicating the degree of reliability of the processing result of a predetermined evaluation process performed based on point group data, based on the base station positional relationship identification data and the terminal station positional relationship identification data stored in the determination result storage unit 34 and the confidence coefficient calculation logic stored in the storage unit 25.

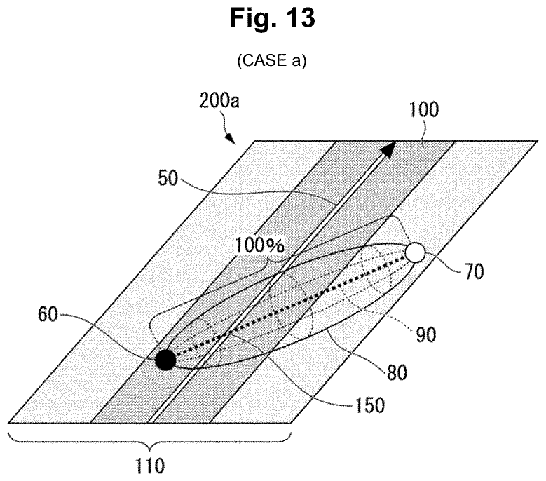

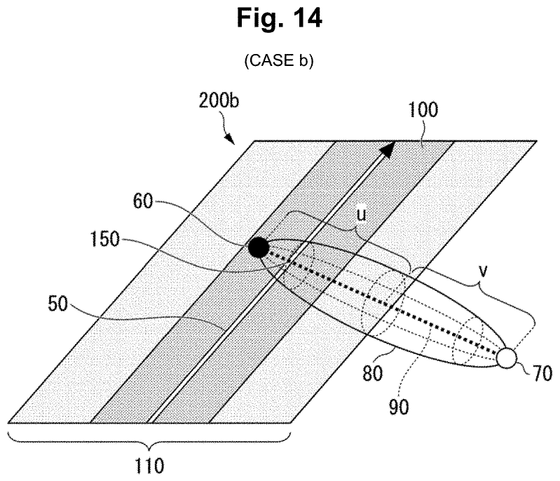

Herein, regarding a case where a connecting line segment 90 crosses the travel trajectory 50, the relationship between the proportion of the connecting line segment 90 included in the measurable range 110 and the reliability of point group data will be described through comparison between the “case a” of the positional relationship configuration 200a illustrated in FIG. 13 and the “case b” of the positional relationship configuration 200b illustrated in FIG. 14. In FIGS. 13 and 14, the point of intersection between the connecting line segment 90 and the travel trajectory 50 is indicated by an intersection point 150. As illustrated in FIG. 13, in the “case a,” the connecting line segment 90 connecting the candidate base station position 60 and the candidate terminal station position 70 is located within the measurable range 110 entirely, that is, at a proportion of 100[%].

In contrast, in the “case b” of the positional relationship configuration 200b illustrated in FIG. 14, the candidate base station position 60 is located within the neighboring range 100, while the candidate terminal station position 70 is located outside the measurable range 110 as described with reference to FIG. 7. In the “case b,” the candidate base station position 60 is located on the left side of the travel trajectory 50, while the candidate terminal station position 70 is located on the right side of the travel trajectory 50. Thus, the connecting line segment 90 crosses the travel trajectory 50. In addition, in FIG. 14, the point of intersection between the connecting line segment 90 and the travel trajectory 50 is the intersection point 150 as in FIG. 13. However, in the “case b,” a part of the connecting line segment 90 is located outside the measurable range 110. Therefore, although the connecting line segment 90 crosses the travel trajectory 50 in the “case b,” it is not appropriate to consider that the reliability of point group data obtained in the “case a” and the reliability of point group data obtained in the “case b” are equal.

Herein, as illustrated in FIG. 14, assume that the length of the connecting line segment 90 on the two-dimensional plane for which the vertical coordinate components are ignored, which is present within the measurable range 110, is “u,” and the length thereof outside the measurable range 110 is “v.” In such a case, the proportion X[%] of the connecting line segment 90 on the two-dimensional plane for which the vertical coordinate components are ignored, which is present within the measurable range 110, can be represented by the following Expression (1).

X=u/(u+v)×100[%] (1)

In the “case b,” regarding the “u” portion present within the measurable range 110, it can be said that the reliability of point group data that can be acquired is equal to the reliability of point group data that can be acquired in the “case a.”

In contrast, regarding the “v” portion present outside the measurable range 110, point group data cannot be acquired. Therefore, in the “case b,” when the overall point group data is considered, the reliability of the point group data is lower than that in the “case a.” In such a case, it is appropriate to consider that the degree of reliability of the processing result of a predetermined evaluation process drops to the proportion of the connecting line segment 90 present within the measurable range 110, that is, X[%]. In the present embodiment, the value of X in Expression (1) above is the confidence coefficient.

It should be noted that the connecting line segment 90 present within the measurable range 110 (that is, the range indicated by “u”) further includes a line segment located within the neighboring range 100 and a line segment located outside the neighboring range 100. The neighboring range 100 is a range closer to the travel trajectory 50 of a mobile object, such as a vehicle, having an MMS mounted thereon. Therefore, the inside of the neighboring range 100 is a range in which point group data can be collected with higher density than in the outside of the neighboring range 100, and thus the reliability is higher. Thus, for example, the aforementioned “u” that represents the length of the connecting line segment 90 on the two-dimensional plane for which the vertical coordinate components are ignored, which is present within the measurable range 110, may be further divided into a length “u₁” present within the neighboring range 100 and a length “u₂” present outside the neighboring range 100, and weighting may be applied such that the value of u₁ becomes larger than that of u₂. Accordingly, the accuracy of the value of the confidence coefficient X can be further increased.

Herein, referring again to FIG. 4, the configuration of the point group data processing unit 6a of the second embodiment will be described. The connecting line segment identification unit 26 generates connecting line segment data indicating the connecting line segment 90 connecting the candidate base station position 60 and the candidate terminal station position 70 based on the candidate base station position data indicating the candidate base station position 60 and the candidate terminal station position data indicating the candidate terminal station position 70.

The measurable range proportion calculation unit 28 calculates the proportion of the connecting line segment 90 present within the measurable range 110.

When the measurable range proportion calculation unit 28 has calculated the proportion X of the connecting line segment 90 present within the measurable range 110, the confidence coefficient identification unit 22a identifies the calculated proportion X as the confidence coefficient.

### Process of Second Embodiment

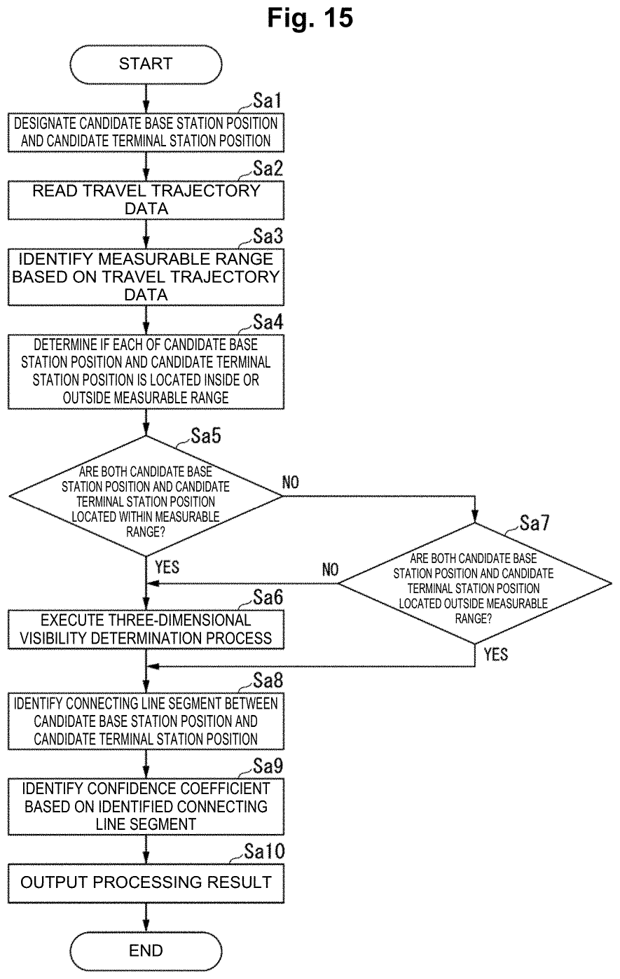

FIG. 15 is a flowchart illustrating a process flow of the point group data processing unit 6a of the second embodiment, and is a process corresponding to the (5) process of determining if communication is possible using three-dimensional point group data in the station deployment support method illustrated in FIG. 2. The flowchart of FIG. 15 illustrates an example in which a three-dimensional visibility determination process of the three-dimensional visibility determination processing unit 23 is applied as a predetermined evaluation process performed by the point group data processing unit 6a.

The candidate three-dimensional position selection unit 20 selects the candidate base station position 60 and the candidate terminal station position 70, and outputs to the positional relationship identification unit 21a candidate base station position data indicating the candidate base station position 60 and candidate terminal station position data indicating the candidate terminal station position 70 (step Sa1). Accordingly, the candidate base station position 60 and the candidate terminal station position 70 as processing targets are designated.

The measurable range identification unit 30 reads the travel trajectory data from the travel trajectory data storage unit 14 (step Sa2). Then, the measurable range identification unit 30 generates measurable range data indicating the measurable range 110 based on the read travel trajectory data and the measurable distance determined in advance (step Sa3). Then, the measurable range identification unit 30 outputs the generated measurable range data to the measurable range presence determination unit 31.

The measurable range presence determination unit 31 captures the candidate base station position data and the candidate terminal station position data output from the candidate three-dimensional position selection unit 20 and the measurable range data output from the measurable range identification unit 30. Then, the measurable range presence determination unit 31 determines if the candidate base station position 60 is located inside or outside the measurable range 110 based on the measurable range data and the candidate base station position data. Then, the measurable range presence determination unit 31 generates the determination result as base station positional relationship identification data, and writes and stores the generated base station positional relationship identification data into the determination result storage unit 34.

In addition, the measurable range presence determination unit 31 determines if the candidate terminal station position 70 is located inside or outside the measurable range 110 based on the measurable range data and the candidate terminal station position data. Then, the measurable range presence determination unit 31 generates the determination result as terminal station positional relationship identification data, and writes and stores the generated terminal station positional relationship identification data into the determination result storage unit 34 (step Sa4).

The measurable range presence determination unit 31 determines if the determination results indicate that both the candidate base station position 60 and the candidate terminal station position 70 are present within the measurable range 110 (step Sa5). If the measurable range presence determination unit 31 determines that the determination results indicate that both the candidate base station position 60 and the candidate terminal station position 70 are present within the measurable range 110 (step Sa5, Yes), the measurable range presence determination unit 31 outputs an instruction signal for instructing the three-dimensional visibility determination processing unit 23 to start a process including the candidate base station position data and the candidate terminal station position data as the processing targets.

In step Sa5, if the measurable range presence determination unit 31 determines “Yes,” the reliability of point group data is high. Thus, it makes sense to perform a three-dimensional visibility determination process.

The three-dimensional visibility determination processing unit 23, upon receiving the instruction signal from the measurable range presence determination unit 31, reads from the point group data storage unit 13 point group data of a space between the candidate base station position 60 corresponding to the candidate base station position data and the candidate terminal station position 70 corresponding to the candidate terminal station position data that are included in the instruction signal, and performs a three-dimensional visibility determination process based on the read point group data (step Sa6).

Meanwhile, if the measurable range presence determination unit 31 determines that the determination results indicate that at least one of the candidate base station position 60 or the candidate terminal station position 70 is not located within the measurable range 110 (step Sa5, No), the measurable range presence determination unit 31 determines if the determination results indicate that both the candidate base station position 60 and the candidate terminal station position 70 are present outside the measurable range 110 (step Sa7).

If the measurable range presence determination unit 31 determines that the determination results indicate that both the candidate base station position 60 and the candidate terminal station position 70 are present outside the measurable range 110 (step Sa7, Yes), the measurable range presence determination unit 31 proceeds with the process to step Sa8. If the measurable range presence determination unit 31 determines “Yes” in step Sa7, point group data has not been acquired from the space between the candidate base station position 60 and the candidate terminal station position 70. Therefore, since it is nonsense to perform a three-dimensional visibility determination process, the process of step Sa6 is not performed.

Meanwhile, if the measurable range presence determination unit 31 determines that the determination results indicate that one of the candidate base station position 60 and the candidate terminal station position 70 is present within the measurable range 110 (step Sa7, No), the measurable range presence determination unit 31 proceeds with the process to step Sa6. If the measurable range presence determination unit 31 determines “No” in step Sa7, it makes some sense to perform a three-dimensional visibility determination process. Therefore, the process of step Sa6 is performed.

It should be noted that among the aforementioned processes, the process of step Sa1 is performed by the candidate three-dimensional position selection unit 20, and the processes of steps Sa2 to Sa7 are performed by the positional relationship identification unit 21a.

The connecting line segment identification unit 26 captures the candidate base station position data and candidate terminal station position data output from the confidence coefficient identification unit 22a. Then, the connecting line segment identification unit 26 generates connecting line segment data indicating the connecting line segment 90 connecting the candidate base station position 60 and the candidate terminal station position 70 based on the captured candidate base station position data and candidate terminal station position data (step Sa8). Then, the connecting line segment identification unit 26 outputs the generated connecting line segment data to the measurable range proportion calculation unit 28.

The measurable range proportion calculation unit 28 captures the connecting line segment data output from the connecting line segment identification unit 26. Then, the measurable range proportion calculation unit 28 reads the travel trajectory data from the travel trajectory data storage unit 14, and calculates the length “u” of the connecting line segment 90 within the measurable range 110 and the length “v” of the connecting line segment 90 outside the measurable range 110 based on the read travel trajectory data, the connecting line segment data, and the measurable distance determined in advance.

The measurable range proportion calculation unit 28 calculates the proportion X[%] of the connecting line segment 90 on the two-dimensional plane for which the vertical coordinate components are ignored, which is present within the measurable range 110, using Expression (1). Then, the measurable range proportion calculation unit 28 outputs to the confidence coefficient identification unit 22a data on the calculated value of X[%] and an output instruction signal.

The confidence coefficient identification unit 22a in a standby state captures the data on the value of X[%] upon receiving the data on the value of X[%] and the output instruction signal from the measurable range proportion calculation unit 28. Then, the confidence coefficient identification unit 22a identifies the value of X[%] as the confidence coefficient (step Sa9).

The confidence coefficient identification unit 22a displays on a screen the candidate base station position data and the candidate terminal station position data stored in the determination result storage unit 34 of the positional relationship identification unit 21a as well as the confidence coefficient, and the three-dimensional visibility determination processing unit 23 displays on the screen the processing result of the three-dimensional visibility determination process (step Sa10). In contrast, when the process of step Sa6 has not been performed and thus the three-dimensional visibility determination processing unit 23 has not output a processing result, the confidence coefficient identification unit 22a displays on the screen the candidate base station position data and the candidate terminal station position data as well as the confidence coefficient, and also displays information that “it has been impossible to perform a three-dimensional visibility determination process” (step Sa10).

It should be noted that in the flowchart illustrated in FIG. 15, although a three-dimensional visibility determination process of the three-dimensional visibility determination processing unit 23 is used as a predetermined evaluation process, a shield factor calculation process of the shield factor calculation unit 24 may be used instead.

In addition, in the processes of steps Sa8 and Sa9 that are performed based on the connecting line segment 90 in the previously described flowchart in FIG. 15, the confidence coefficient may be identified by not only considering the proportion of the connecting line segment 90 present within the measurable range 110 but also considering the proportion of the connecting line segment 90 present within the neighboring range 100.

In the station deployment support apparatus of the second embodiment, the connecting line segment identification unit 26 generates connecting line segment data indicating the connecting line segment 90 connecting the candidate base station position 60 and the candidate terminal station position 70 based on the candidate base station position data and the candidate terminal station position data. The confidence coefficient identification unit 22a identifies the confidence coefficient X indicating the degree of reliability of the processing result of a predetermined evaluation process performed based on point group data, based on the proportion of the connecting line segment 90 present within the measurable range 110.

Accordingly, the confidence coefficient identification unit 22 can present to the user the confidence coefficient indicating the degree of reliability of the processing result of a predetermined evaluation process performed based on the point group data, for each candidate base station position and each candidate terminal station position. Therefore, when not all pieces of point group data have been acquired from the space between the candidate base station position and the candidate terminal station position, the reliability of the point group data is low, and in such a case, it is possible to allow the user to recognize from the confidence coefficient that the reliability of the processing result of a predetermined evaluation process performed using the point group data is also low.

For example, suppose that not all pieces of point group data have been acquired, but the three-dimensional visibility determination processing unit 23 indicates “visible” as a result of a determination process or the shield factor calculation unit 24 indicates “a sufficiently low shield factor that meets the requirement for wireless communication” as a result of a calculation process. Even in such a case, it is possible to urge the user to take precautions by presenting a confidence coefficient with a small value. Accordingly, it is possible to prevent the user from making erroneous determination, for example, selecting candidate positions for installing a base station and a terminal station in a space from which point group data, which serves as a basis for three-dimensional visibility determination or shield factor calculation, has not been acquired.

In addition, identifying the confidence coefficient can prompt the user to make the following determination depending on whether the value of the confidence coefficient is large or small. For example, suppose that not all pieces of point group data have been acquired from the space between the candidate base station position and the candidate terminal station position, but the value of the confidence coefficient is large. In such a case, it is possible to prompt the user to, regarding the combination of the candidate base station position and the candidate terminal station position to be considered, determine that consideration using the acquired point group data is possible.

Further, identifying the confidence coefficient can also allow the three-dimensional visibility determination processing unit 23 to determine whether to perform a three-dimensional visibility determination process or allow the shield factor calculation unit 24 to determine whether to calculate the shield factor depending on whether the value of the confidence coefficient is large or small. For example, the three-dimensional visibility determination processing unit 23 or the shield factor calculation unit 24 may be configured to, when the value of the confidence coefficient is small, not perform a process for a combination of the candidate base station position and the candidate terminal station position as the processing targets, so that the amount of calculation can be reduced. Further, when the user is notified of the fact that the three-dimensional visibility determination processing unit 23 or the shield factor calculation unit 24 has not performed a process, the user can be prompted to acquire point group data again from the space between the candidate base station position and the candidate terminal station position as the processing targets or reconsider the candidate base station position and the candidate terminal station position. Therefore, even when the state of acquisition of point group data from the space between the candidate base station position and the candidate terminal station position is not good, the user can perform appropriate station deployment design.

### Third Embodiment

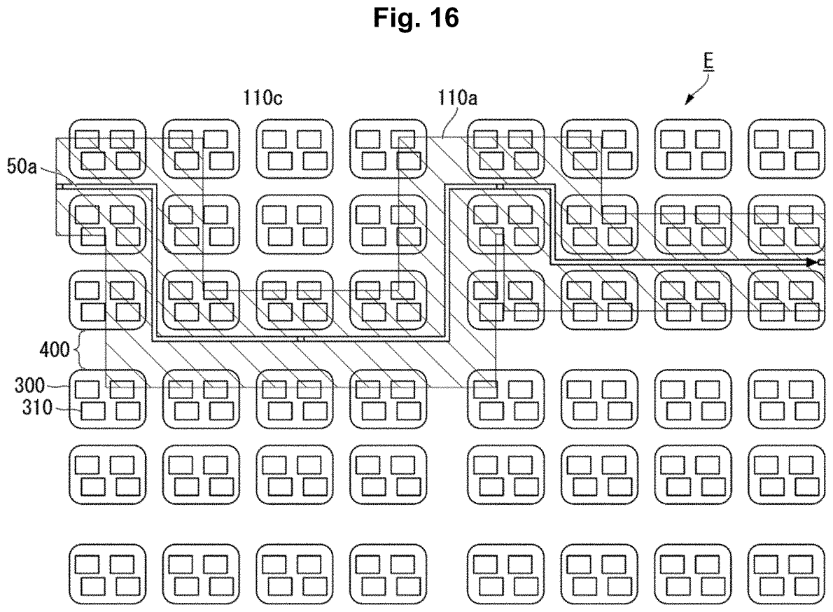

Hereinafter, a third embodiment of the present invention will be described with reference to the drawings. First, with reference to FIGS. 16 to 19, the positional relationship between an evaluation area E described below and the travel trajectory 50, given as an example of the present embodiment, will be described.

FIG. 16 is a view representing a map of an urban area. It should be noted that the map illustrated in FIG. 9 described previously corresponds to an upper left portion of the map illustrated in FIG. 16. In FIG. 16, a region of the road 400 is illustrated in a lattice pattern as in FIG. 9. Each of a plurality of regions partitioned in a lattice pattern by the regions of the road 400 is the site 300. Each site 300 includes a plurality of buildings 310 indicated by a rectangular shape. FIG. 16 also illustrates a travel trajectory 50a of a mobile object, such as a vehicle, having an MMS mounted thereon, and a measurable range 110a is illustrated along the travel trajectory 50a. It should be noted that in FIGS. 16 to 19, the illustration of the aforementioned neighboring range 100 is omitted.

In the present embodiment, it is assumed that the range of the map illustrated in FIG. 16 is the evaluation area E. The evaluation area E is a target area for the user to perform station deployment design of base stations and terminal stations. Therefore, it is desirable that the measurable range 110 spread across the entire evaluation area E. However, as illustrated in FIG. 16, the measurable range 110a that is based on the travel trajectory 50a does not cover the entire evaluation area E.

It should be noted that there are a variety of reasons that the measurable range 110a that is based on the travel trajectory 50a cannot cover the entire evaluation area E. For example, there is a range in which a mobile object, such as a vehicle, having an MMS mounted thereon is not allowed to travel due to traffic regulations or the like (for example, due to one-way traffic, prohibition of right and left turns at an intersection or straight travel, or regulations due to construction).

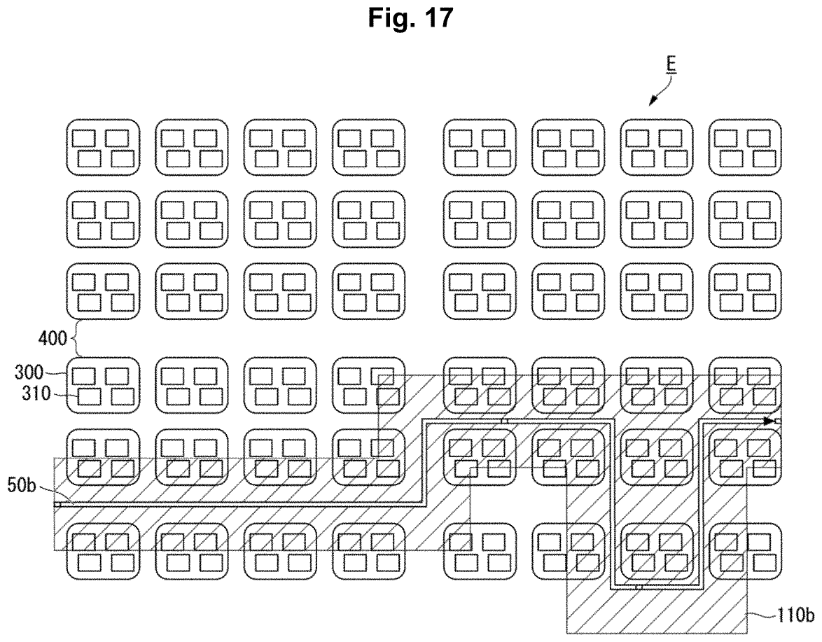

FIGS. 17 to 19 each represent a map of an urban area corresponding to the same range as that of the evaluation area E illustrated in FIG. 16. FIG. 17 illustrates a travel trajectory 50b of a mobile object, such as a vehicle, having an MMS mounted thereon, and a measurable range 110b is illustrated along the travel trajectory 50b. As illustrated in FIG. 17, the measurable range 110b that is based on the travel trajectory 50b does not cover the entire evaluation area E as with the measurable range 110a illustrated in FIG. 16.

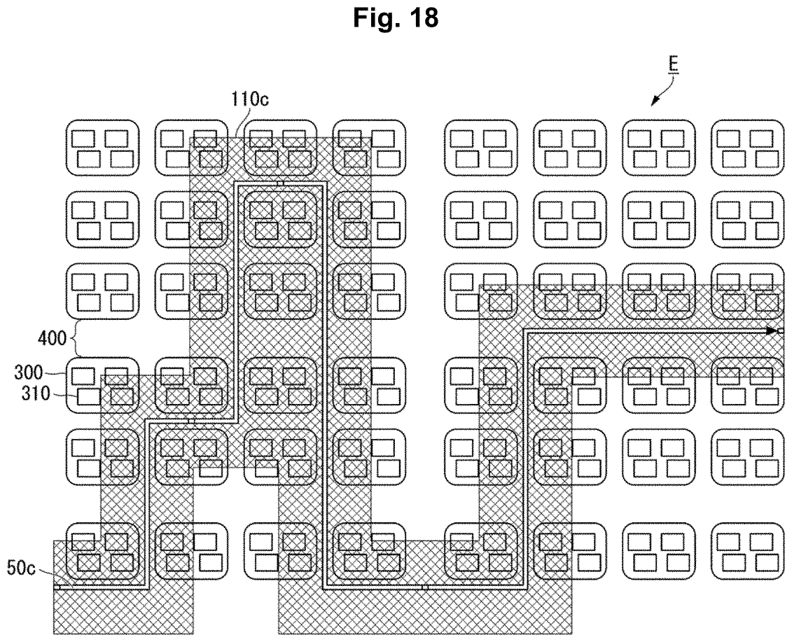

In addition, FIG. 18 illustrates a travel trajectory 50c of a mobile object, such as a vehicle, having an MMS mounted thereon, and a measurable range 110c is illustrated along the travel trajectory 50c. As illustrated in FIG. 18, the measurable range 110c that is based on the travel trajectory 50c does not cover the entire evaluation area E as with the measurable range 110a illustrated in FIG. 16.

As described above, the travel trajectories 50a to 50c illustrated in FIGS. 16 to 18, respectively, are different travel trajectories, and the measurable ranges 110a to 110c are different measurable ranges. In addition, none of the measurable ranges 110a to 110c covers the entire evaluation area E.

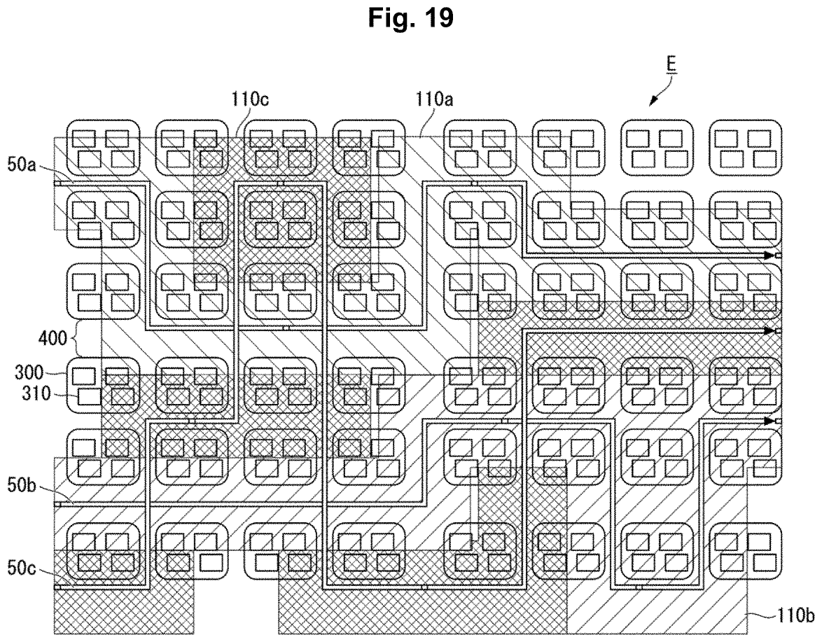

Meanwhile, in FIG. 19, all of the travel trajectories 50a to 50c and the measurable ranges 110a to 110c illustrated in FIGS. 16 to 18, respectively, are illustrated in a map. In this manner, combining the measurable ranges 110 that are based on the plurality of travel trajectories 50 allows more regions of the evaluation area E to be included in the measurable range 110.

For example, for each of a total of 48 sites 300 (hereinafter also referred to as “plots”) included in the evaluation area E, the number of buildings 310 in the measurable range 110a illustrated in FIG. 16 is counted. Each plot included in the evaluation area E includes about four buildings 310. In FIG. 16, the number of plots in which 3 to 4 buildings 310 are included in the measurable range 110a, the number of plots in which 1 to 2 buildings 310 are included in the measurable range 110a, and the number of plots in which no building 310 is present in the measurable range 110a are 14 plots, 11 plots, and 23 plots, respectively.

Similarly, for example, for each of a total of 48 plots included in the evaluation area E, the number of buildings 310 in the measurable range 110b illustrated in FIG. 17 is counted. In FIG. 17, the number of plots in which 3 to 4 buildings 310 are included in the measurable range 110b, the number of plots in which 1 to 2 buildings 310 are included in the measurable range 110b, and the number of plots in which no building 310 is present in the measurable range 110b are 12 plots, 9 plots, and 27 plots, respectively.

Similarly, for example, for each of a total of 48 plots included in the evaluation area E, the number of buildings 310 in the measurable range 110c illustrated in FIG. 18 is counted. In FIG. 18, the number of plots in which 3 to 4 buildings 310 are included in the measurable range 110b, the number of plots in which 1 to 2 buildings 310 are included in the measurable range 110b, and the number of plots in which no building 310 is present in the measurable range 110b are 19 plots, 14 plots, and 15 plots, respectively.

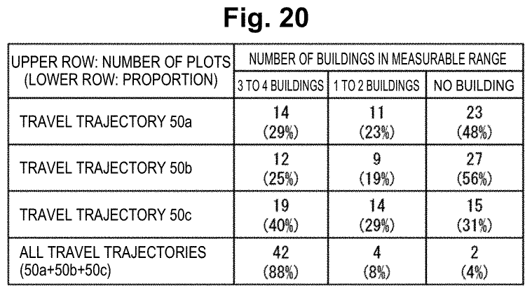

FIG. 20 is a table aggregating the aforementioned count results. As illustrated in FIG. 20, regarding each of the measurable range 110a that is based on travel trajectory 50a, the measurable range 110b that is based on the travel trajectory 50b, and the measurable range 110c that is based on the travel trajectory 50c, the number of plots in which 3 to 4 buildings 310 are included in the measurable range 110a, the measurable range 110b, or the measurable range 110c is 12 to 19 plots at the most, and its proportion is about 25[%] to 40[%] at the most. In addition, even when counting is performed by further including the number of plots in which 1 to 2 buildings 310 are included in the measurable range 110a, the measurable range 110b, or the measurable range 110c, the number of plots in which 1 to 4 buildings 310 are included in the measurable range 110a, the measurable range 110b, or the measurable range 110c is about 21 to 33 plots at the most, and its proportion is about 44[%] to 69[%].

In contrast, as illustrated in FIG. 20, regarding the measurable range 110 combining the measurable range 110a that is based on the travel trajectory 50a, the measurable range 110b that is based on the travel trajectory 50b, and the measurable range 110c that is based on the travel trajectory 50c, the number of plots in which 3 to 4 buildings 310 are included in the measurable range 110 is increased up to 42 plots, and its proportion is increased up to 88[%]. In addition, when counting is performed by further including the number of plots in which 1 to 2 buildings 310 are included in the measurable range 110 (which combines the measurable range 110a, the measurable range 110b, and the measurable range 110c), the number of plots in which 1 to 4 buildings 310 are included in the measurable range 110 is increased up to 46 plots, and its proportion is increased up to 96[%].

In this manner, when the measurable ranges 110 that are based on the plurality of travel trajectories 50 are superposed, in the case of the examples illustrated in FIGS. 16 to 20, for example, the probability that both the candidate base station position 60 and the candidate terminal station position 70 are included in the measurable range 110 (which combines the measurable range 110a, the measurable range 110b, and the measurable range 110c) is at least 77[%](=88[%]×88[%]). Meanwhile, when the measurable range 110 is only the measurable range 110a that is based on the travel trajectory 50a illustrated in FIG. 16, for example, the probability that both the candidate base station position 60 and the candidate terminal station position 70 are included in the measurable range 110 (which includes only the measurable range 110a) is about 8[%](=29[%]×29[%]).

In this manner, when point group data is acquired based on the plurality of travel trajectories 50 (which include the travel trajectory 50a, the travel trajectory 50b, and the travel trajectory 50c), the region of the measurable range 110 (which combines the measurable range 110a, the measurable range 110b, and the measurable range 110c) is significantly expanded. Accordingly, it is possible to improve the accuracy of visibility determination or shield factor calculation (that is, increase the value of the confidence coefficient), and thus improve the accuracy of station deployment design.

Hereinafter, the configuration of a point group data processing unit 6b of the third embodiment will be described.

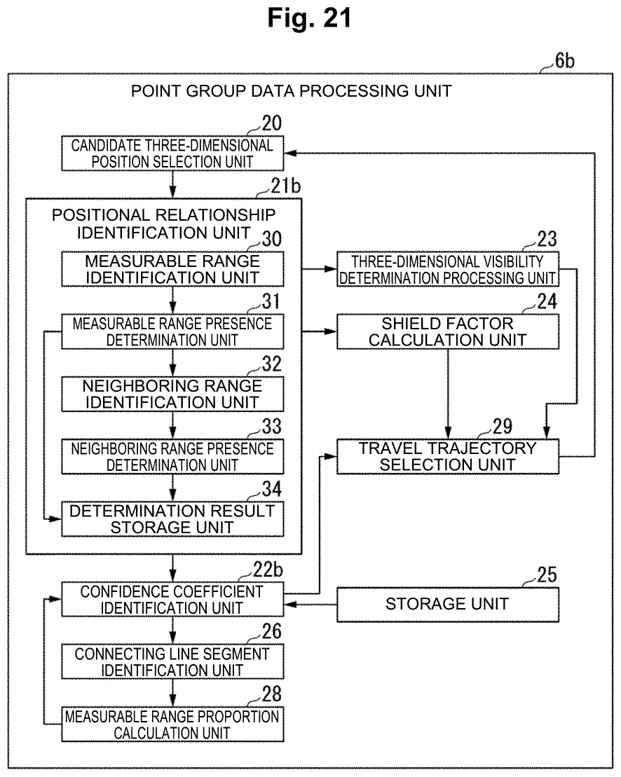

FIG. 21 is a block diagram illustrating the internal configuration of the point group data processing unit 6b applied to the third embodiment. In the third embodiment, components identical to those of the first embodiment and the second embodiment are denoted by identical reference signs. In the following description, a station deployment support apparatus of the third embodiment shall be referred to as a station deployment support apparatus 1b with a reference sign “1b” added thereto, though not illustrated in the drawings. The station deployment support apparatus 1b has a configuration obtained by replacing the point group data processing unit 6 in the station deployment support apparatus 1 of the first embodiment with the point group data processing unit 6b illustrated in FIG. 21.

The point group data processing unit 6b includes the candidate three-dimensional position selection unit 20, a positional relationship identification unit 21b, a confidence coefficient identification unit 22b, the three-dimensional visibility determination processing unit 23, the shield factor calculation unit 24, the storage unit 25, the connecting line segment identification unit 26, the measurable range proportion calculation unit 28, and a travel trajectory selection unit 29. The positional relationship identification unit 21b includes the measurable range identification unit 30, the measurable range presence determination unit 31, the neighboring range identification unit 32, the neighboring range presence determination unit 33, and the determination result storage unit 34. In this manner, the point group data processing unit 6b has a configuration obtained by adding the travel trajectory selection unit 29 to the point group data processing unit 6a of the second embodiment illustrated in FIG. 4.

The travel trajectory selection unit 29 calculates the proportion of a portion of the evaluation area E within the measurable range 110 that is based on the existing travel trajectory 50. If the calculated proportion is less than a predetermined threshold (for example, 70[%]), the travel trajectory selection unit 29 determines if there is any other (new) travel trajectory 50 that achieves a high proportion when the measurable range 110 that is based on the other (new) travel trajectory 50 is combined with the measurable range 110 that is based on the existing travel trajectory 50. If there is any other travel trajectory 50 that achieves a high proportion, the travel trajectory selection unit 29 causes the measurable range identification unit 30 to read from the travel trajectory data storage unit 14 travel trajectory data indicating the other (new) travel trajectory 50.

Although the travel trajectory selection unit 29 in the present embodiment is configured to, based on the proportion of a portion of the evaluation area E within the measurable range 110 that is based on the existing travel trajectory 50, determine whether to use point group data that is based on another (new) travel trajectory 50, the present invention is not limited thereto. For example, the travel trajectory selection unit 29 may perform the determination using a visibility determination result of the three-dimensional visibility determination processing unit 23, a shield factor calculation result of the shield factor calculation unit 24, a confidence coefficient calculation result of the confidence coefficient identification unit 22b and the like.

### Process of Third Embodiment

Hereinafter, an exemplary process of the point group data processing unit 6b will be described.

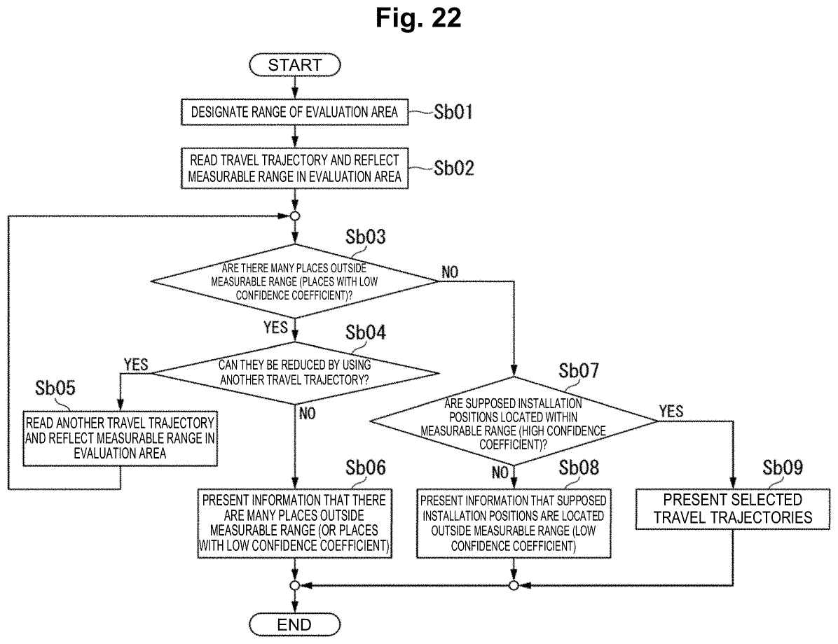

FIG. 22 is a flowchart illustrating a process flow of the point group data processing unit 6b of the third embodiment. First, the point group data processing unit 6b designates the range of the evaluation area E (step Sb01). Next, the point group data processing unit 6b reads the first travel trajectory data. Then, the point group data processing unit 6b reflects the measurable range 110, which is based on the read travel trajectory data, in the evaluation area E (step Sb02).

The point group data processing unit 6b calculates the proportion of a portion of the evaluation area E within the measurable range 110 that is based on the existing travel trajectory 50, for example, thereby determining if there are many places outside the measurable range 110 (step Sb03). Alternatively, the point group data processing unit 6b determines if there are many places with a low confidence coefficient regarding the visibility or the shield factor of a space between the candidate base station position 60 and the candidate terminal station position 70 in the evaluation area E, for example (step Sb03).

If the point group data processing unit 6b determines that there are many places outside the measurable range 110 (or determines that there are many places with a low confidence coefficient) (step Sb03, Yes), the point group data processing unit 6b determines if there is any other (new) travel trajectory 50 that can reduce the places outside the measurable range 110 (or the places with a low confidence coefficient) when the measurable range 110 that is based on the other (new) travel trajectory 50 is combined with the measurable range 110 that is based on the existing travel trajectory 50 (step Sb04).

If the point group data processing unit 6b determines that there is another (new) travel trajectory 50 that can reduce the places outside the measurable range 110 (or the places with a low confidence coefficient) (step Sb04, Yes), the point group data processing unit 6b selects the other (new) travel trajectory 50 and reads travel trajectory data indicating the selected travel trajectory 50. Then, the point group data processing unit 6b reflects the measurable range 110, which is based on the read travel trajectory data, in the evaluation area E (step Sb05). Then, the point group data processing unit 6b repeats the operation of from step Sb03 again.

Meanwhile, if the point group data processing unit 6b determines that there is no other (new) travel trajectory 50 that can reduce the places outside the measurable range 110 (or the places with a low confidence coefficient) (step Sb04, No), the point group data processing unit 6b presents to the user information indicating that there are many places outside the measurable range 110 (or places with a low confidence coefficient) (step Sb06). Accordingly, the process of the point group data processing unit 6b illustrated in the flowchart of FIG. 22 ends.

Meanwhile, if the point group data processing unit 6b determines that there are not many places outside the measurable range 110 (step Sb03, No), the point group data processing unit 6b determines if the supposed candidate base station position 60 and candidate terminal station position 70 are located within the measurable range 110 (step Sb07). Alternatively, if the point group data processing unit 6b determines that there are not many places with a low confidence coefficient (step Sb03, No), the point group data processing unit 6b determines if the supposed candidate base station position 60 and candidate terminal station position 70 are the positions where the confidence coefficient (of visibility determination or shield factor calculation) is higher (than a predetermined value, for example) (step Sb07).

If the point group data processing unit 6b determines that the supposed candidate base station position 60 and candidate terminal station position 70 are not located within the measurable range 110 (step Sb07, No), the point group data processing unit 6b presents to the user information indicating that the supposed candidate base station position 60 and candidate terminal station position 70 are outside the measurable range 110 (step Sb08). Alternatively, if the point group data processing unit 6b determines that the supposed candidate base station position 60 and candidate terminal station position 70 are not the positions where the confidence coefficient is high (step Sb07, No), the point group data processing unit 6b presents to the user information indicating that the supposed candidate base station position 60 and candidate terminal station position 70 are the positions where the confidence coefficient is low (step Sb08). Accordingly, the process of the point group data processing unit 6b illustrated in the flowchart of FIG. 22 ends.

Meanwhile, if the point group data processing unit 6b determines that the supposed candidate base station position 60 and candidate terminal station position 70 are located within the measurable range 110 (step Sb07, Yes), the point group data processing unit 6b presents to the user information indicating all of the selected travel trajectories 50 (step Sb09).

Alternatively, if the point group data processing unit 6b determines that the supposed candidate base station position 60 and candidate terminal station position 70 are the positions where the confidence coefficient is high (step Sb07, Yes), the point group data processing unit 6b presents to the user information indicating all of the selected travel trajectories 50 (step Sb09). Accordingly, the process of the point group data processing unit 6b illustrated in the flowchart of FIG. 22 ends.

As described above, the point group data processing unit 6b in the station deployment support apparatus 1b of the third embodiment includes the travel trajectory selection unit 29 that selects at least one piece of travel trajectory data so that the proportion of the predetermined evaluation area E occupied by the measurable range 110 satisfies a predetermined value, for example. With such a configuration, the station deployment support apparatus 1b can improve the state of acquisition of point group data from the space between the candidate base station position 60 and the candidate terminal station position 70. This allows the user to perform appropriate station deployment design.

### Fourth Embodiment

Hereinafter, a fourth embodiment of the present invention will be described with reference to the drawings.

In the following description, a station deployment support apparatus of the fourth embodiment shall be referred to as a station deployment support apparatus 1c with a reference sign “1c” added thereto. In addition, a point group data processing unit in the station deployment support apparatus 1c of the fourth embodiment shall be referred to as a point group data processing unit 6c with a reference sign “6c” added thereto.

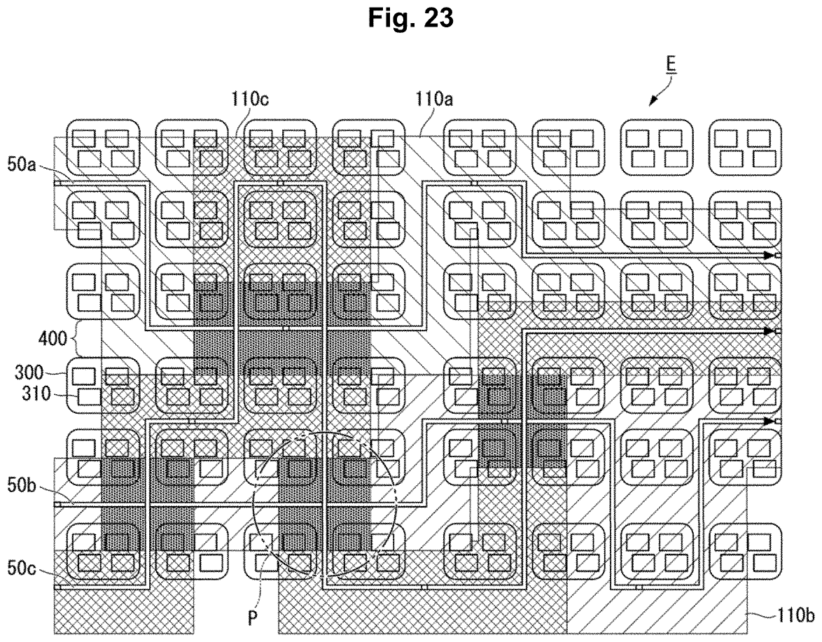

FIG. 23 is a view representing a map of an urban area. FIG. 23 illustrates the evaluation area E, the travel trajectories 50a to 50c, and the measurable ranges 110a to 110c illustrated in FIG. 19 described previously. However, FIG. 23 differs from FIG. 19 in that FIG. 23 illustrates an overlap (hereinafter referred to as an “overlapped area”) of two of the measurable ranges 110a to 110c that occur when two of the travel trajectories 50a to 50c cross each other.

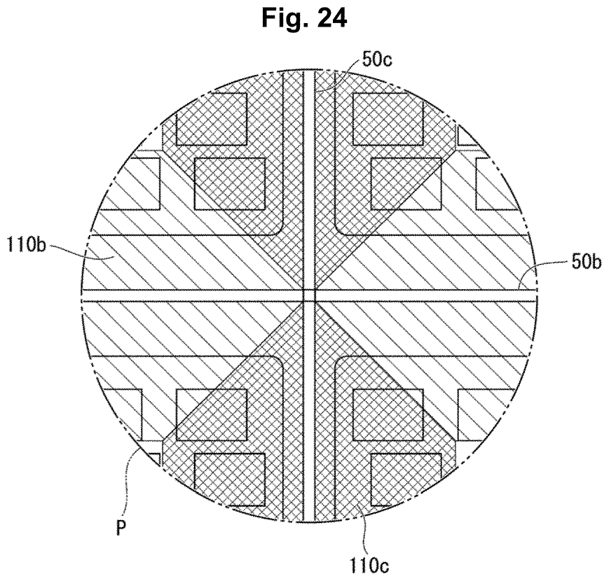

FIG. 23 illustrates five overlapped areas (each corresponding to an intersection of different travel trajectories in the example illustrated in FIG. 23). FIG. 24 is an enlarged view of a range P including one of the overlapped areas illustrated in FIG. 23. As illustrated in FIG. 24, the range P includes an overlapped area of the measurable range 110b corresponding to the travel trajectory 50b and the measurable range 110c corresponding to the travel trajectory 50c.

In the overlapped area, a mobile object, such as a vehicle, having an MMS mounted thereon travels a plurality of times. Thus, point group data is collected a plurality of times. Therefore, in the overlapped area illustrated in FIG. 24, station deployment setting can be performed using either point group data in the measurable range 110b or point group data in the measurable range 110c. However, point group data is collected at a higher density at a position closer to the travel trajectory 50. In addition, when point group data collected at a higher density is used, the accuracy of station deployment design improves. Therefore, which of the accuracy of station deployment design performed using point group data in the measurable range 110b or that performed using point group data in the measurable range 110c is higher differs depending on the position of the candidate base station position 60 or the candidate terminal station position 70 in the overlapped area.

FIG. 24 illustrates each of a region in which station deployment design can be performed with higher accuracy using point group data in the measurable range 110b and a region in which station deployment design can be performed with higher accuracy using point group data in the measurable range 110c. As illustrated in FIG. 24, a line connecting the intersection of the travel trajectory 50b and the travel trajectory 50c and each apex of the overlapped area is the boundary between the region in which station deployment design can be performed with higher accuracy using point group data in the measurable range 110b and the region in which station deployment design can be performed with higher accuracy using point group data in the measurable range 110c.

The point group data processing unit 6c in the station deployment support apparatus 1c of the fourth embodiment performs, when one of the candidate base station position 60 or the candidate terminal station position 70 is located in the overlapped area, visibility determination or shield factor calculation using point group data in the measurable range 110 with which station deployment design can be performed with higher accuracy. The point group data in the measurable range 110 with which station deployment design can be performed with higher accuracy is the point group data included in the measurable range 110 that is based on the travel trajectory 50 located closer to the candidate base station position 60 or the candidate terminal station position 70 as described above. Accordingly, the station deployment support apparatus 1c of the fourth embodiment can further improve the accuracy of station deployment design.

In addition, as described above, since a mobile object, such as a vehicle, having an MMS mounted thereon travels in the overlapped area a plurality of times, point group data is collected a plurality of times. Herein, an environment, such as road conditions, may differ at a timing when the mobile object, such as a vehicle, having an MMS mounted thereon travels along the travel trajectory 50b and at a timing when the mobile object travels along the travel trajectory 50c. For example, there is a case where visibility is shielded when the mobile object passes a large vehicle or the like during acquisition of point group data at one of the two timings. In addition, for example, there is also a case where visibility is shielded when a large vehicle or the like stops on the side of the road during acquisition of point group data at one of the two timings.

As described above, there is a case where point group data in the measurable range 110b and point group data in the measurable range 110c in the overlapped area do not coincide due to the difference in the timing of collecting such point group data. However, based on such point group data being different, the station deployment support apparatus 1c can recognize the overlapped area as a place where the communication state is likely to fluctuate (i.e., the communication stability is low), for example. In addition, the station deployment support apparatus 1c can present to the user information that the overlapped area is a place where the communication state is likely to fluctuate, for example.

As described above, the point group data processing unit 6c in the station deployment support apparatus 1c of the fourth embodiment performs, when the measurable ranges 110 that are based on the plurality of travel trajectories 50 selected by the travel trajectory selection unit 29 overlap one another, a predetermined evaluation process (i.e., a visibility determination process or a shield factor calculation process) based on point group data included in the measurable range 110 that is based on the travel trajectory 50 located closer to a position indicated by the candidate base station position 60 or the candidate terminal station position 70. Accordingly, the station deployment support apparatus 1c of the fourth embodiment can improve the accuracy of station deployment design more.

### Fifth Embodiment

Hereinafter, a fifth embodiment of the present invention will be described with reference to the drawings.

In the following description, a station deployment support apparatus of the fifth embodiment shall be referred to as a station deployment support apparatus 1d with a reference sign “1d” added thereto. In addition, a point group data processing unit in the station deployment support apparatus 1d of the fifth embodiment shall be referred to as a point group data processing unit 6d with a reference sign “6d” added thereto.

In the fifth embodiment, a mobile object, such as a vehicle, having an MMS mounted thereon travels along an identical travel trajectory 50 a plurality of times. Accordingly, the station deployment support apparatus 1d of the present embodiment can collect pieces of point group data measured a plurality of times at an identical location at different timings.

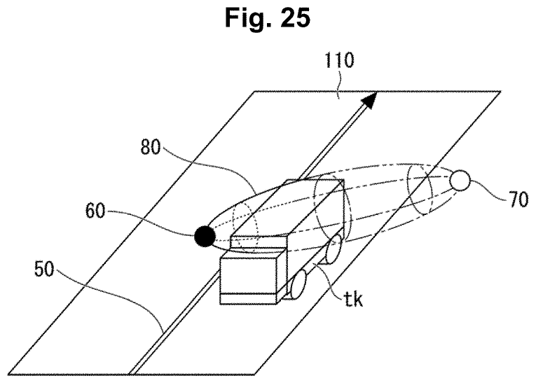

FIG. 25 illustrates the state at a given timing of a place corresponding to the “case b” represented by the positional relationship configuration 200b in FIG. 7 described previously. As illustrated in FIG. 25, a truck tk stops between the candidate base station position 60 and the candidate terminal station position 70. Therefore, the Fresnel zone 80 between the candidate base station position 60 and the candidate terminal station position 70 is shielded by the truck tk. When point group data obtained at a timing when the truck tk stops around the candidate base station position 60 and the candidate terminal station position 70 is used, the visibility determination result of the three-dimensional visibility determination processing unit 23 indicates “not visible.” In addition, when point group data obtained at such a timing is used, the shield factor calculation result of the shield factor calculation unit 24 indicates a “high shield factor.”

However, at a timing when no vehicle, such as a truck tk, stops around the candidate base station position 60 and the candidate terminal station position 70, the Fresnel zone 80 between the candidate base station position 60 and the candidate terminal station position 70 is not shielded. Therefore, when point group data obtained at a timing when no vehicle, such as a truck tk, stops around the candidate base station position 60 and the candidate terminal station position 70 is used, the visibility determination result of the three-dimensional visibility determination processing unit 23 indicates “visible.” In addition, when point group data obtained at such a timing is used, the shield factor calculation result of the shield factor calculation unit 24 indicates a “low shield factor.”

The station deployment support apparatus 1d of the present embodiment can, by comparing pieces of point group data measured a plurality of times at an identical location at different timings, estimate whether an object shielding a space between the candidate base station position 60 and the candidate terminal station position 70 is an object that is always present or an object that is temporarily present (such as a truck tk that temporarily stops as described above, for example).

In addition, the station deployment support apparatus 1d of the present embodiment can recognize the frequency (or the proportion) of the presence of an object that temporarily shields the Fresnel zone 80 between the candidate base station position 60 and the candidate terminal station position 70 by performing visibility determination or shield factor calculation using pieces of point group data repeatedly measured at an identical location at different timings. Accordingly, the station deployment support apparatus 1d can estimate the likelihood of fluctuation of the communication state (i.e., communication stability). In addition, the station deployment support apparatus 1d can present the estimation result to the user.

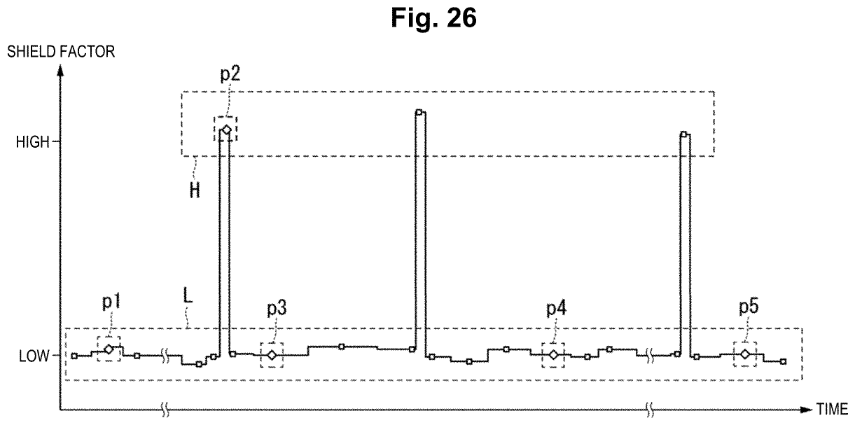

FIG. 26 is a graph illustrating an exemplary transition of the shield factor of a space between a given candidate base station position 60 and a given candidate terminal station position 70. In the graph illustrated in FIG. 26, the ordinate axis represents the shield factor and the abscissa axis represents the time (in FIG. 26, the range in which the shield factor is high is indicated by H, and the range in which the shield factor is low is indicated by L). As illustrated in FIG. 26, there are three timings when the shield factor is particularly high within the time illustrated in the graph. Each of the timings when the shield factor is particularly high (such as a measurement point p2 in the range indicated by H in FIG. 26) is a timing when a large vehicle or the like temporarily stops between the candidate base station position 60 and the candidate terminal station position 70 as illustrated in FIG. 25, for example.

In the time period in which the shield factor has transitioned to a low level (i.e., the range indicated by L including measurement points p1 and p3 to p5 in FIG. 26), the shield factor fluctuates slightly. Such fluctuation occurs when a small vehicle, a passenger, or the like passes, for example. A mobile object, such as a vehicle, having an MMS mounted thereon travels at five timings including p1 to p5, for example, within the time illustrated in the graph to acquire point group data. Among such five timings, only the timing p2 is a timing when a large vehicle or the like temporarily stops between the candidate base station position 60 and the candidate terminal station position 70.

Therefore, since the shield factor has been high only in one measurement among the five measurements, the station deployment support apparatus 1d of the present embodiment can estimate that the shield factor is at a low level in about 80[%] of the total time period, for example. Although an example in which five measurement points are used has been briefly described with reference to the graph in FIG. 26, it is obviously necessary to utilize a number of measurement points to present a more precise numerical proportion of the time period in which the shield factor is low. In addition, the station deployment support apparatus 1d can present to the user an estimation result indicating that the combination of the candidate base station position 60 and the candidate terminal station position 70 as the evaluation targets is a combination of positions where communication is generally possible.

### Process of Fifth Embodiment

Hereinafter, an exemplary process of the station deployment support apparatus 1d will be described.

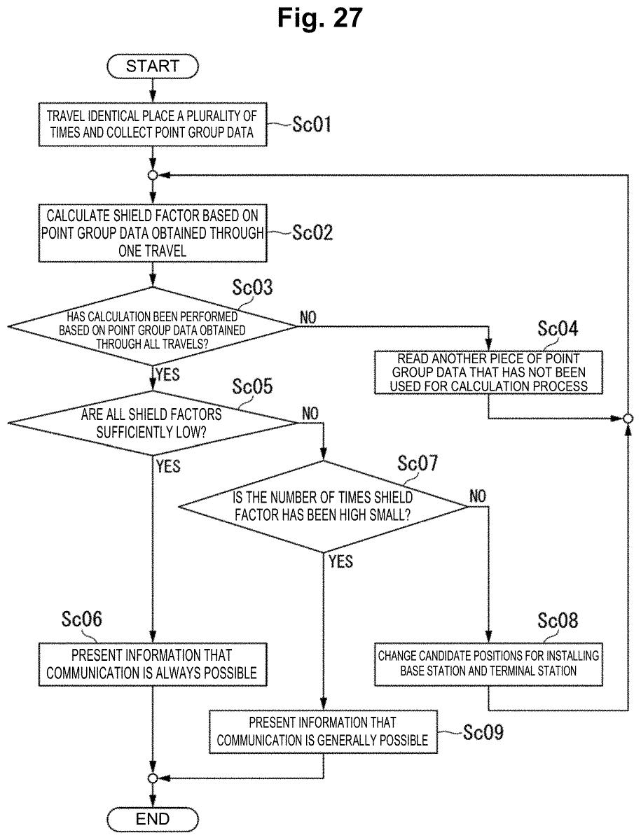

FIG. 27 is a flowchart illustrating a process flow of the station deployment support apparatus 1d of the fifth embodiment.

When a mobile object, such as a vehicle, having an MMS mounted thereon has traveled an identical place a plurality of times, the point group data processing unit 6d collects point group data obtained through each travel (step Sc01). Then, the point group data processing unit 6d calculates the shield factor of the space between the candidate base station position 60 and the candidate terminal station position 70 based on point group data obtained through a given travel among the collected pieces of point group data (step Sc02).

Then, the point group data processing unit 6d determines if the shield factor of the space between the candidate base station position 60 and the candidate terminal station position has been calculated based on point group data obtained through all travels (step Sc03). If it is determined that there is another piece of point group data that has not been used for the calculation of the shield factor of the space between the candidate base station position 60 and the candidate terminal station position 70 (step Sc03, No), the point group data processing unit 6d reads the other piece of point group data that has not been used for the calculation (step Sc04). Then, the point group data processing unit 6d repeats the processes of from step Sc02 described above again.

Meanwhile, if the point group data processing unit 6d determines that the shield factor of the space between the candidate base station position 60 and the candidate terminal station position 70 has been calculated based on point group data obtained through all travels (step Sc03, Yes), the point group data processing unit 6d determines if all of the calculated shield factors are sufficiently low values (step Sc05). It should be noted that the point group data processing unit 6d performs such determination based on whether all of the calculated shield factors are less than or equal to a predetermined value determined in advance by the user, for example.

If it is determined that all of the calculated shield factors are sufficiently low values (step Sc05, Yes), the station deployment support apparatus 1d presents to the user information indicating that the combination of the candidate base station position 60 and the candidate terminal station position 70, which are the evaluation targets, is a combination where communication is always possible (step Sc06). Accordingly, the processes illustrated in the flowchart of FIG. 27 end.

Meanwhile, if it is determined that at least one of the calculated shield factors is not a sufficiently low value (step Sc05, No), the point group data processing unit 6d determines if the number of times the shield factor has been high is small (step Sc07). It should be noted that the point group data processing unit 6d performs such determination based on whether the number of times the shield factor has not been determined to be a low value (that is, the number of times the shield factor has been determined to be a high value) is less than or equal to the number of times determined in advance by the user, for example.

If it is determined that the number of times the shield factor has been high is not small (that is, large) (step Sc07, No), the point group data processing unit 6d changes the candidate base station position 60 and the candidate terminal station position 70 as the evaluation targets (step Sc08). Then, the point group data processing unit 6d repeats the processes of from step Sc02 described above again.

Meanwhile, if it is determined that the number of times the shield factor has been high is small (step Sc07, Yes), the station deployment support apparatus 1d presents to the user information indicating that the combination of the candidate base station position 60 and the candidate terminal station position 70, which are the evaluation targets, is a combination where communication is generally possible (that is, communication is possible at many timings) (step Sc09). Accordingly, the processes illustrated in the flowchart of FIG. 27 end.

Although the point group data processing unit 6d in the present embodiment is configured to determine if the combination of the candidate base station position 60 and the candidate terminal station position 70 is a combination where communication is possible based on the calculation results of the shield factors, the present invention is not limited thereto. For example, the point group data processing unit 6d may be configured to determine if the combination of the candidate base station position 60 and the candidate terminal station position 70 is a combination where communication is possible based on the determination result of visibility.

As described above, the point group data processing unit 6d in the station deployment support apparatus 1d of the fifth embodiment performs, based on an identical candidate base station position 60, an identical candidate terminal station position 70, and a plurality of pieces of point group data obtained at different timings, a predetermined evaluation process (i.e., a visibility determination process or a shield factor calculation process) for each piece of the point group data. Then, the station deployment support apparatus 1d generates information about the communication state based on the result of the predetermined evaluation process obtained for each piece of the point group data, and presents the information. The information about the communication state herein is information indicating the likelihood of fluctuation of the communication state (i.e., communication stability), for example, as described above. With such a configuration, the station deployment support apparatus 1d of the fifth embodiment can further improve the accuracy of station deployment design.

### Sixth Embodiment

Hereinafter, a sixth embodiment of the present invention will be described with reference to the drawings.

In the following description, a station deployment support apparatus of the sixth embodiment shall be referred to as a station deployment support apparatus 1e with a reference sign “1e” added thereto. In addition, a point group data processing unit in the station deployment support apparatus 1e of the sixth embodiment shall be referred to as a point group data processing unit 6e with a reference sign “6e” added thereto.

In the sixth embodiment, a mobile object, such as a vehicle, having an MMS mounted thereon travels along an identical travel trajectory 50 a plurality of times as in the aforementioned fifth embodiment. Accordingly, the station deployment support apparatus 1e of the present embodiment can collect pieces of point group data measured a plurality of times at an identical location at different timings.

It should be noted that the sixth embodiment differs from the aforementioned fifth embodiment in that the fifth embodiment is intended to estimate the influence of a temporary stop of a large vehicle or the like on the communication (that is, a change in the communication state that occurs in a relatively short period of time), for example, while the sixth embodiment is intended to estimate the influence of a phenomenon that occurs depending on the period (e.g., the season) on the communication (that is, a change in the communication state that occurs in a relatively long period of time), for example. Therefore, the length of each of a plurality travels of a mobile object, such as a vehicle, having an MMS mounted thereon is typically longer in the sixth embodiment than in the fifth embodiment.

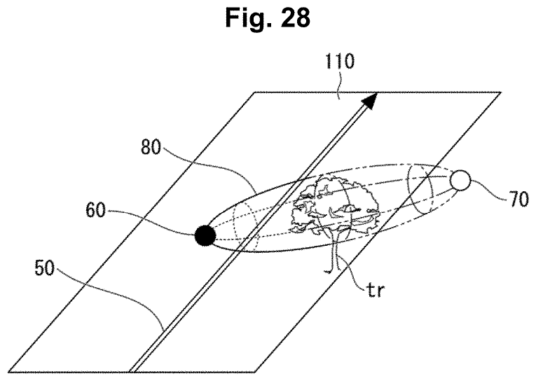

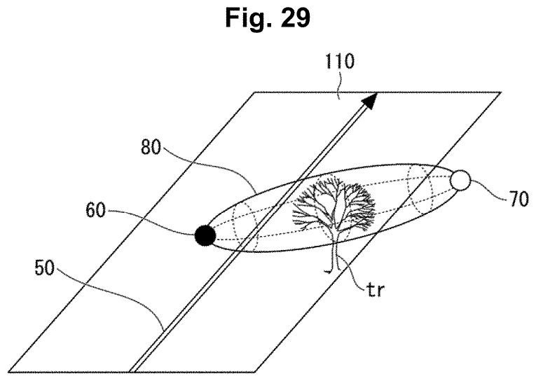

FIGS. 28 and 29 each illustrate the state at a given timing of a place corresponding to the “case b” represented by the positional relationship configuration 200b in FIG. 7 described previously. As illustrated in FIGS. 28 and 29, a tree tr is present between the candidate base station position 60 and the candidate terminal station position 70. The tree tr is a broad-leaved tree, and in FIG. 28, the tree tr is in a densely grown state. That is, FIG. 28 illustrates the spring or summer season as the timing, for example. Therefore, the Fresnel zone 80 between the candidate base station position 60 and the candidate terminal station position 70 is shielded by the tree tr.

As roadside trees, broad-leaved trees (or deciduous trees) are planted for the reasons that tree-shaded areas are provided in the summer and sunlight is received in the winter, for example. Therefore, when a road and an its surrounding area are supposed, the candidate base station position 60 illustrated in FIG. 28 or FIG. 29 corresponds to a utility pole on the side of the road. In addition, the candidate terminal station position 70 corresponds to a wall surface of a building around the road. Further, the tree tr as a roadside tree, which is planted between the candidate positions of the two stations, is present. That is, when the road on which such a tree tr is present and its surrounding area are seen, the sixth embodiment (i.e., the circumstance illustrated in FIG. 28 or FIG. 29, for example) illustrates a commonly supposed circumstance.

When point group data, which is obtained at a timing when the neighboring tree tr has grown densely, is used, the visibility determination result of the three-dimensional visibility determination processing unit 23 indicates “not visible.” In addition, when point group data obtained at such a timing is used, the shield factor calculation result of the shield factor calculation unit 24 indicates a “high shield factor.”

Meanwhile, in FIG. 29, the tree tr has its leaves fallen off. That is, FIG. 29 illustrates the autumn or winter season as the timing, for example. Therefore, the Fresnel zone 80 between the candidate base station position 60 and the candidate terminal station position 70 is not shielded by the tree tr much. When point group data, which is obtained at a timing when the neighboring tree tr has its leaves fallen off, is used, the visibility determination result of the three-dimensional visibility determination processing unit 23 indicates “visible.” In addition, when point group data obtained at such a timing is used, the shield factor calculation result of the shield factor calculation unit 24 indicates a “low shield factor.”

The station deployment support apparatus 1e of the present embodiment can, by comparing pieces of point group data measured a plurality of times at an identical location at different timings with one another, estimate whether a phenomenon that shields the space between the candidate base station position 60 and the candidate terminal station position 70 is a phenomenon that occurs always or a phenomenon that occurs depending on the period (like the tree tr with its state of leaves changing depending on the season, for example).

In addition, the station deployment support apparatus 1e of the present embodiment can, by performing visibility determination or shield factor calculation using pieces of point group data repeatedly measured at an identical location at different timings, recognize the period of the occurrence of a phenomenon that shields the Fresnel zone 80 between the candidate base station position 60 and the candidate terminal station position 70. Accordingly, the station deployment support apparatus 1e can estimate the period in which the communication state is good (or bad). In addition, the station deployment support apparatus 1e can present the estimation result to the user.

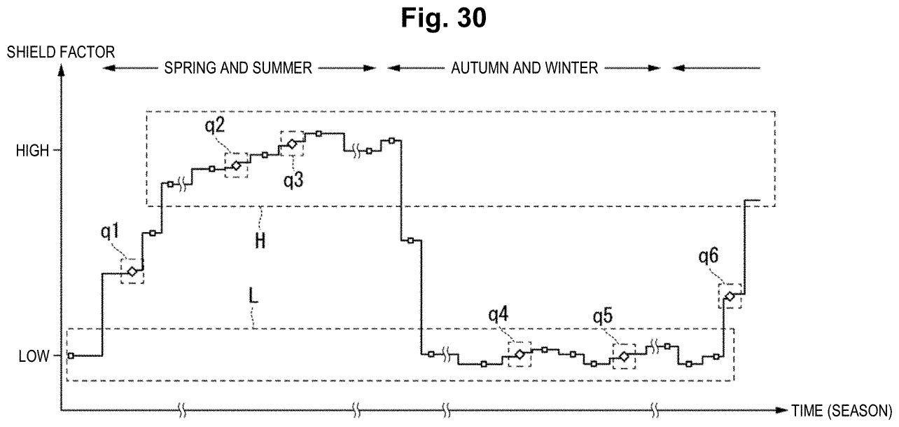

FIG. 30 is a graph illustrating an exemplary transition of the shield factor of a space between a given candidate base station position 60 and a given candidate terminal station position 70. In the graph illustrated in FIG. 30, the ordinate axis represents the shield factor and the abscissa axis represents the time (i.e., the season) (in FIG. 30, the range in which the shield factor is high is indicated by H, and the range in which the shield factor is low is indicated by L). As illustrated in FIG. 30, there is a period in which the shield factor is high within the time illustrated in the graph. Such a timing when the shield factor is high is a timing when the leaves of the tree tr present between the candidate base station position 60 and the candidate terminal station position 70 have grown densely as illustrated in FIG. 28, for example. Meanwhile, as illustrated in FIG. 30, there is also a period in which the shield factor is low within the time illustrated in the graph. Such a timing when the shield factor is low is a timing when the leaves of the tree tr present between the candidate base station position 60 and the candidate terminal station position 70 have fallen off as illustrated in FIG. 29, for example.

A mobile object, such as a vehicle, having an MMS mounted thereon travels at 6 timings including q1 to q6, for example, within the time illustrated in the graph, to acquire point group data. Among such 6 timings, each of the timings q2 and q3 (i.e., measurement points in the range H in which the shield factor is high in FIG. 30) is the spring or summer timing, and thus is a timing when the leaves of the tree tr between the candidate base station position 60 and the candidate terminal station position 70 have grown densely. In addition, among such 6 timings, each of the timings q4 and q5 (i.e., measurement points in the range L in which the shield factor is low in FIG. 30) is the autumn or winter timing, and thus is a timing when the leaves of the tree tr between the candidate base station position 60 and the candidate terminal station position 70 have fallen off. Further, among such 6 timings, each of the timings q1 and q6 (i.e., measurement points outside the range H in which the shield factor is high and outside the range L in which the shield factor is low in FIG. 30) is a timing when the state of the leaves of the tree tr between the candidate base station position 60 and the candidate terminal station position 70 is between the aforementioned two states.

Therefore, the station deployment support apparatus 1e of the present embodiment can estimate that the shield factor is high in the spring and summer timings and the shield factor is low in the autumn and winter timings, for example. In addition, the station deployment support apparatus 1e can present to the user an estimation result indicating that the combination of the candidate base station position 60 and the candidate terminal station position 70, which are the evaluation targets, is a combination of positions where the communication state is bad in the spring and summer but is good in the autumn and winter. Accordingly, the user can recognize that such a combination of the two stations is a combination that can be used only in a limited period of time.

### Process of Sixth Embodiment

Hereinafter, an exemplary process of the station deployment support apparatus 1e will be described.

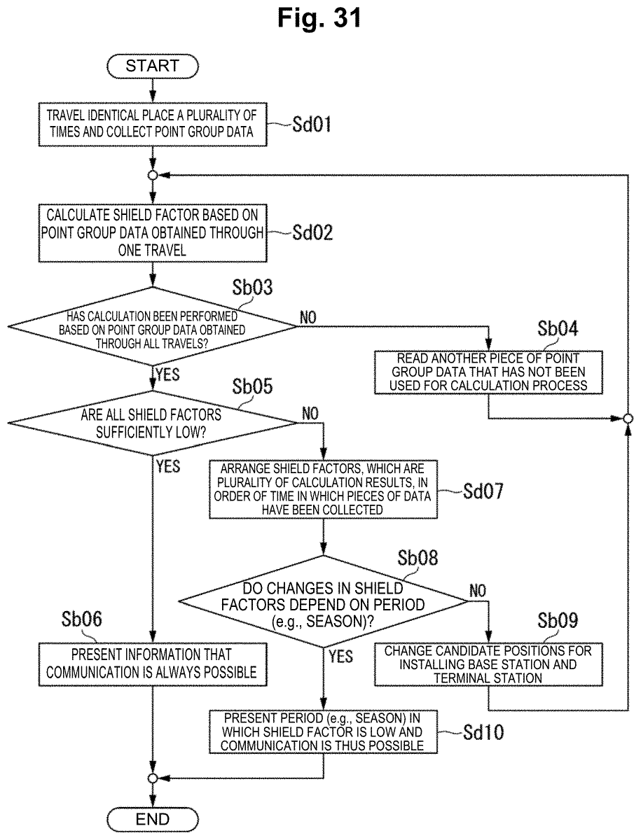

FIG. 31 is a flowchart illustrating a process flow of the station deployment support apparatus 1e of the sixth embodiment.

When a mobile object, such as a vehicle, having an MMS mounted thereon has traveled an identical place a plurality of times, the point group data processing unit 6e collects point group data obtained through each travel (step Sd01). Then, the point group data processing unit 6e calculates the shield factor of the space between the candidate base station position 60 and the candidate terminal station position 70 based on point group data obtained through a given travel among the collected pieces of point group data (step Sd02).

Then, the point group data processing unit 6e determines if the shield factor of the space between the candidate base station position 60 and the candidate terminal station position has been calculated based on point group data obtained through all travels (step Sd03). If it is determined that there is another piece of point group data that has not been used for the calculation of the shield factor of the space between the candidate base station position 60 and the candidate terminal station position 70 (step Sd03, No), the point group data processing unit 6e reads the other piece of point group data that has not been used for the calculation (step Sd04). Then, the point group data processing unit 6e repeats the processes of from step Sd02 described above again.

Meanwhile, if the point group data processing unit 6e determines that the shield factor of the space between the candidate base station position 60 and the candidate terminal station position 70 has been calculated based on point group data obtained through all travels (step Sd03, Yes), the point group data processing unit 6e determines if all of the calculated shield factors are sufficiently low values (step Sd05). It should be noted that the point group data processing unit 6e performs such determination based on whether all of the calculated shield factors are less than or equal to a predetermined value determined in advance by the user, for example.

If it is determined that all of the calculated shield factors are sufficiently low values (step Sd05, Yes), the station deployment support apparatus 1e presents to the user information indicating that the combination of the candidate base station position 60 and the candidate terminal station position 70, which are the evaluation targets, is a combination where communication is always possible (step Sd06). Accordingly, the processes illustrated in the flowchart of FIG. 31 end.

Meanwhile, if it is determined that at least one of the calculated shield factors is not a sufficiently low value (step Sd05, No), the point group data processing unit 6e arranges (rearranges) the values of the shield factors, which are the plurality of calculation results, in order of time in which the pieces of point group data have been collected (step Sd07). Then, the point group data processing unit 6e determines, based on the values of the shield factors arranged in order of time, if changes in the shield factors depend on the period (e.g., the season) (step Sd08). It should be noted that the point group data processing unit 6e performs such determination based on whether it is possible to divide the whole period into a period in which the shield factors determined to be not low values (that is, determined to be high values) are arranged in succession, and a period in which the shield factors determined to be low values are arranged in succession, for example.

If it is determined that changes in the shield factors do not depend on the period (e.g., the season) (step Sd08, No), the point group data processing unit 6e changes the candidate base station position 60 and the candidate terminal station position 70 as the evaluation targets (step Sd09). Then, the point the group data processing unit 6e repeats the processes of from step Sd02 described above again.

If it is determined that changes in the shield factors depend on the period (e.g., the season) (step Sd08, Yes), the station deployment support apparatus 1e presents to the user information indicating the period (e.g., the season) in which the shield factor is low and communication is thus possible for the combination of the candidate base station position 60 and the candidate terminal station position 70 as the evaluation targets (step Sd10). Accordingly, the processes illustrated in the flowchart of FIG. 31 end.

Although the point group data processing unit 6e in the present embodiment is configured to determine if the combination of the candidate base station position 60 and the candidate terminal station position 70 is a combination where communication is possible based on the calculation result of shield factors, the present invention is not limited thereto. For example, the point group data processing unit 6e may be configured to determine if the combination of the candidate base station position 60 and the candidate terminal station position 70 is a combination where communication is possible based on the determination result of visibility.

As described above, the point group data processing unit 6e in the station deployment support apparatus 1e of the sixth embodiment performs, based on an identical candidate base station position 60, an identical candidate terminal station position 70, and a plurality of pieces of point group data obtained at different timings, a predetermined evaluation process (i.e., a visibility determination process or a shield factor calculation process) for each piece of the point group data. Then, the station deployment support apparatus 1e presents information obtained by associating the period (e.g., the season) with the communication state based on the result of the predetermined evaluation process obtained for each piece of the point group data (e.g., the result of comparison of a plurality of results of the predetermined evaluation process). The information about the communication state herein is information indicating the likelihood of fluctuation of the communication state (i.e., communication stability), for example, as described above. With such a configuration, the station deployment support apparatus 1e of the sixth embodiment can further improve the accuracy of station deployment design.

Although the aforementioned first to sixth embodiments have exemplarily illustrated millimeter-wave wireless communication as the wireless communication performed between a base station apparatus installed at the candidate base station position 60 and a terminal station apparatus installed at the candidate terminal station position 70, communication other than the millimeter-wave wireless communication may also be performed, such as terrestrial digital communication, satellite radio communication, or communication for which UHF (Ultra High Frequency) is used.

In the aforementioned first to sixth embodiments, the determination processes are performed using an inequality sign or an inequality sign with an equality sign. However, the present invention is not limited to such embodiments, and the determination processes including determination conditions such as “if/whether . . . is greater than,” “if/whether . . . is less than,” “if/whether . . . is greater than or equal to,” and “if/whether . . . is less than or equal to” are only exemplary. Thus, depending on the way in which thresholds are determined, such determination processes may be replaced with determination processes including determination conditions such as “if/whether . . . is greater than or equal to,” “if/whether . . . is less than or equal to,” “if/whether . . . is greater than,” and “if/whether . . . is less than,” respectively. In addition, the thresholds used for such determination processes are also only exemplary. Thus, different thresholds may be applied to the respective determination processes.

The station deployment support apparatus 1 (1a to 1e) in each of the aforementioned embodiments may be implemented by a computer. In such a case, it is possible to implement the apparatus by recording a program for implementing the function of the apparatus on a computer readable recording medium and causing a computer system to read the program recorded on the recording medium and thus execute the program. It should be noted that the “computer system” herein includes hardware, such as an OS and peripheral devices. In addition, the “computer readable recording medium” refers to a portable medium, such as a flexible disk, a magneto-optical disk, ROM, or CD-ROM; or a storage device, such as a hard disk, incorporated in the computer system. Further, the “computer readable recording medium” may include a medium that dynamically holds a program for a short period of time, such as a communication line used for transmitting a program via a network like the Internet or a communication line like a telephone line; and a medium that holds a program for a given period of time, such as a volatile memory in a computer system that serves as a server or a client in the aforementioned case. In addition, the aforementioned program may be a program for implementing a part of the aforementioned function, or a program that can implement the aforementioned function by being combined with a program already recorded on the computer system. Alternatively, the aforementioned program may be a program implemented using a programmable logic device, such as an FPGA (Field Programmable Gate Array).

Although the embodiments of the invention have been described in detail with reference to the drawings, specific configurations are not limited thereto and thus include design that is within the spirit and scope of the invention.

### INDUSTRIAL APPLICABILITY

When performing station deployment design for determining the places for installing a wireless base station and a wireless terminal station by utilizing point group data, it is possible to apply the point group data to the determination of visibility or the calculation of the shield factor for a space between a base station to be installed in an outdoor facility, such as a utility pole, and a terminal station to be installed on a wall surface of a building.

### REFERENCE SIGNS LIST

1 (1a to 1e) Station deployment support apparatus
2 Design area designation unit
3 Candidate base station position extraction unit
4 Candidate terminal station position extraction unit
5 Determination processing unit
6 (6a to 6e) Point group data processing unit
7 Number-of-stations calculation unit
10 Operation processing unit
11 Map data storage unit
12 Facility data storage unit
13 Point group data storage unit
14 Travel trajectory data storage unit
15 Determination result storage unit
21 (21a, 21b) Positional relationship identification unit
22 (22a, 22b) Confidence coefficient identification unit
23 Determination processing unit
24 Shield factor calculation unit
25 Storage unit
26 Connecting line segment identification unit
28 Measurable range proportion calculation unit
29 Travel trajectory selection unit
30 Measurable range identification unit
31 Measurable range presence determination unit
32 Neighboring range identification unit
33 Neighboring range presence determination unit
34 Determination result storage unit
50 (50a to 50f) Travel trajectory
60 (60b, 60d) Candidate base station position
70 (70b, 70d, 70x, 70y) Candidate terminal station position
80 (80b, 80d) Fresnel zone
90 (90x, 90y) Connecting line segment
100 Neighboring range
110 (110a, 110b, 110c) Measurable range
200 (200a to 200g) Positional relationship configuration
300 (300a, 300b, 300m, 300n) Site
310 (310a-1, 310b-1) Building
320 (320a-1 to 320a-3) Tree
330 (330b) Signboard
400 Road
800, 801 Building
810 to 812 House
821 to 826 Utility pole
830 to 834 Base station (base station apparatus)
840 to 844 Terminal station (terminal station apparatus)
850 to 851 Telephone exchange station
900 to 901 Optical fiber

1. A station deployment support method comprising:
a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position;
a measurable range identification step of generating measurable range data indicating a measurable range based on the travel trajectory data and the measurable distance; and
a travel trajectory selection step of selecting at least one piece of travel trajectory data so that a proportion of the measurable range in a predetermined evaluation area satisfies a predetermined value.

2. The station deployment support method according to claim 1, further comprising, when measurable ranges that are based on a plurality of pieces of travel trajectory data selected in the travel trajectory selection step overlap one another:
a first point group data processing step of performing a predetermined evaluation process based on the point group data included in the measurable range that is based on the travel trajectory closer to a position indicated by the base station positional relationship identification data or a position indicated by the terminal station positional relationship identification data.

3. The station deployment support method according to claim 1, further comprising:
a second point group data processing step of, based on identical candidate base station position data, identical candidate terminal station position data, and a plurality of pieces of point group data obtained at different timings, performing a predetermined evaluation process for each piece of the point group data; and
a presenting step of presenting information about a communication state based on a result of the predetermined evaluation process obtained for each piece of the point group data.

4. The station deployment support method according to claim 3, wherein the presenting step includes presenting information obtained by associating a period with the communication state.

5. The station deployment support method according to claim 3, wherein the information about the communication state is information indicating stability of communication between the base station apparatus and the terminal station apparatus.

6. A station deployment support apparatus comprising:
a positional relationship identification unit that, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generates base station positional relationship identification data indicating a positional relationship between the travel trajectory and a candidate base station position, and terminal station positional relationship identification data indicating a positional relationship between the travel trajectory and a candidate terminal station position;
a measurable range identification unit that generates measurable range data indicating a measurable range based on the travel trajectory data and the measurable distance; and
a travel trajectory selection unit that selects at least one piece of travel trajectory data so that a proportion of the measurable range in a predetermined evaluation area satisfies a predetermined value.

7. A station deployment support program for causing a computer to execute:
a positional relationship identification step of, based on travel trajectory data indicating a travel trajectory of a mobile object that measures an object present in a three-dimensional space within a predetermined measurable distance and acquires point group data indicating a position of the measured object in the three-dimensional space, the measurable distance, candidate base station position data indicating a candidate position for installing a base station apparatus, and candidate terminal station position data indicating a candidate position for installing a terminal station apparatus, generating base station positional relationship identification data indicating a positional relationship between the travel trajectory and a candidate base station position, and terminal station positional relationship identification data indicating a positional relationship between the travel trajectory and a candidate terminal station position;
a measurable range identification step of generating measurable range data indicating a measurable range based on the travel trajectory data and the measurable distance; and
a travel trajectory selection step of selecting at least one piece of travel trajectory data so that a proportion of the measurable range in a predetermined evaluation area satisfies a predetermined value.
